(19) United States
(12) Patent Application Publication
(10) Pub. No.: US 2026/0132084 A1
(43) Pub. Date: May 14, 2026

(54) MULTI-FUNCTIONAL REFRACTORY MATERIALS, AND USES THEREOF

(71) Applicant: KARSTEN MANUFACTURING CORPORATION, Phoenix, AZ (US)

(72) Inventor: Ian R. S. Day, Scottsdale, AZ (US)

(73) Assignee: KARSTEN MANUFACTURING CORPORATION, Phoenix, AZ (US)

(21) Appl. No.: 19/384,979

(22) Filed: Nov. 10, 2025

Related U.S. Application Data
(60) Provisional application No. 63/718,399, filed on Nov. 8, 2024.
(60) Provisional application No. 63/736,533, filed on Dec. 19, 2024.
(60) Provisional application No. 63/775,527, filed on Mar. 21, 2025.

(51) Int. Cl. C04B 35/14; B65D 25/04; B65D 25/14; B65D 25/34; B65D 65/40

(52) U.S. Cl. CPC C04B 35/14; B65D 25/04; B65D 25/14; B65D 25/34; B65D 65/403; C04B 2235/3201; C04B 2235/3206; C04B 2235/3208; C04B 2235/3217; C04B 2235/3244; C04B 2235/3418; C04B 2235/3463; C04B 2235/762; C04B 2235/765

(57) ABSTRACT

A refractory material has a crystalline lattice structure and a dry weight. The refractory material composition is based on the dry weight of the refractory material and comprises a silica content of about 70.00% to about 97.00% by weight. The silica content further comprises a silica weight, a silica phase composition, trace amounts of quartz, a zirconia content, and an alumina content. The refractory material can be placed within packaging. The packaging comprises a plurality of panels, wherein each panel has an inner wall, an outer wall, a corrugation separated into a plurality of flutes, and a first refractory material comprising a first particle size disposed within the plurality of flutes.

### CROSS REFERENCE TO RELATED APPLICATIONS

This claims the benefit of U.S. Provisional Application No. 63/775,527, filed on Mar. 21, 2025, U.S. Provisional Application No. 63/736,533, filed on Dec. 19, 2024, and U.S. Provisional Application No. 63/718,399, filed on Nov. 8, 2024, all of which are incorporated by reference in their entirety.

### TECHNICAL FIELD

This disclosure relates generally to materials for mitigating fire, heat, and chemical hazards.

### BACKGROUND

Silica-based refractory materials are widely recognized for their thermal stability, chemical inertness, and structural resilience. These materials have long been employed in high-temperature industrial environments such as furnaces, kilns, and foundries. Their ability to withstand extreme heat without degradation makes them indispensable in applications requiring prolonged exposure to elevated temperatures. Additionally, their resistance to corrosive substances has led to their use in chemically aggressive settings, including acid-resistant linings and containment vessels. Despite their robust performance in industrial contexts, the use of silica-based refractory material has remained largely confined to static, heavy-duty installations. As such, conventional applications typically involve castables or coatings designed for permanent infrastructure. These formats, while effective in their intended roles, are ill-suited for integration into lightweight, mobile, or consumer-facing products. As a result, the broader potential of these materials to contribute to safety in everyday and specialist environments has been underutilized.

Additionally, the fire protection and chemical spill fields continue to rely on materials that often present trade-offs between performance, cost, and versatility. Conventional fire-resistant packaging commonly employs polymer-based barriers or coatings that may degrade under sustained heat, fail to prevent ignition, emit hazardous fumes, or some combination thereof. Conventional spill control products, such as sorbent granules, are typically formulated for specific chemical classes and thus lack universal compatibility across acids, bases, and neutral liquids. Further, conventional spill control products may initially absorb hazardous liquids, but they often lack long-term retention capabilities, leading to the gradual release of volatile compounds or toxic fumes into the surrounding environment. Many of these solutions are single-use, non-recyclable, and limited in their ability to provide simultaneous thermal and chemical protection.

Further, there remains a significant gap in that art for materials that combine high thermal resistance, broad-spectrum chemical sorbency, and structural adaptability in formats suitable for various applications, such as packaging, emergency response tools, and surface coatings. Existing technologies do not adequately address the need for multifunctional safety materials that can be integrated into diverse environments without compromising performance or usability.

### BRIEF DESCRIPTION OF THE DRAWINGS

To facilitate further description of the embodiments, the following drawings are provided in which:

FIG. 1 illustrates a schematic diagram of polymorphic phase transformations of silica as a function of temperature.

FIG. 2 is a black and white photograph of an enlarged particle of refractory material, including a magnified detail view of the particle.

FIG. 3 illustrates a schematic diagram of a tetragonal crystalline lattice comprising repeating SiO₄ tetrahedra according to the present invention.

FIG. 4 illustrates a schematic diagram of a cubic crystalline lattice comprising repeating SiO₄ tetrahedra according to the present invention.

FIG. 5 illustrates an enlarged top plan view of a corrugated packaging panel with refractory material according to the present invention.

FIG. 6 illustrates an enlarged side elevation view of the corrugated packaging panel of FIG. 5, in cross-section.

FIG. 7 illustrates a perspective view of a corrugated package with refractory material according to the present invention.

FIG. 8 illustrates a top plan view of the corrugated package of FIG. 6 with a refractory material sub-divider in a parallel configuration.

FIG. 9 illustrates a top plan view of the corrugated package of FIG. 6 with a refractory material sub-divider in a diagonal configuration.

FIG. 10 illustrates a top plan view of the corrugated package of FIG. 6 with a secondary package and refractory material.

FIG. 11 illustrates a table comparing the neutralization and temperature rise of a control neutralizer and an exemplary neutralizer.

FIG. 12 illustrates a table comparing the thermal resistance of various substances in a simulated non-venting event.

FIG. 13 illustrates a table comparing the thermal resistance of various substances in a simulated venting event.

FIG. 14 illustrates a table comparing the necessary velocities and forces for initial and complete degradation of various substances.

FIG. 15 illustrates a table comparing the necessary absorbent amount for absorbing sulfuric acid.

FIG. 16 illustrates a table comparing the necessary absorbent amount for absorbing sodium hydroxide.

FIG. 17 illustrates a table comparing the flame test results for cardboard insulated with various substances.

FIG. 18 illustrates a table comparing the oil extraction results of a refractory material from various soils.

FIG. 19 illustrates a table comparing the sludge formation of various substances.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denotes the same elements.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or being carried out in various ways.

### DETAILED DESCRIPTION

Refractory materials are described herein that are cost-effective, durable, and mitigate fire, heat, and chemical hazards. The materials are thermally and chemically resilient and can be provided in lightweight, scalable formats to meet the evolving demands of modern safety standards. The materials are thermally stable to withstand extreme temperatures without structural degradation, and chemically inert across a wide pH spectrum to safely interact with a broad range of hazardous substances, including acids, bases, and neutral liquids. Many forms of refractory materials have high porosity and surface area to absorb and retain liquids while minimizing the risk of re-release or vaporization.

The refractory material further can be processed into lightweight powders or granules that are scalable for use in industrial and consumer environments, such as packaging, emergency response, and/or construction domains. In some embodiments, for example, the refractory materials are embedded into corrugated packaging materials to transform conventional packaging into fire-resistant containers capable of withstanding elevated temperatures during transport or storage. In other embodiments, the refractory materials are used for universal spill control enabling safe containment of acids, bases, and neutral chemicals, thereby reducing the risk of secondary exposure or airborne toxins. In other embodiments, the refractory materials are integrated into textiles or coatings to improve fire resistance.

### I. Definitions

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood as connecting two or more elements or signals, electrically, mechanically and/or otherwise, directly or indirectly.

The term “refractory material” in the description should be broadly understood as any composition primarily comprising mineral-based compounds that exhibit high thermal stability, chemical inertness, and structural durability under elevated temperatures. These materials may have a variety of physical forms, including but not limited to powders, granules, small or large particles, molded blocks, sheets, or coatings. The refractory material may be engineered or processed to suit specific integration needs and may include additives or binders that do not substantially alter its core thermal and chemical properties.

The terms “Ceramic Shell Material” or “CSM” should be understood to be a specific embodiment of a refractory material comprising silica-based compounds primarily in the cristobalite phase. Similar to the refractory material defined above, Ceramic Shell Material is thermally stable, chemically inert, and structurally durable under elevated temperatures. Ceramic Shell Material may be provided in different physical forms as defined above. In some embodiments, the CSM is formed as a byproduct of an investment casting process.

The terms “cristobalite” or “cristobalite phase” in the description should be understood as a high-temperature phase of silica (SiO₂), characterized by a cubic and tetragonal crystal structure suitable for absorbing heat and retaining liquids. Due to its thermal and surface properties, cristobalite-phased silica is often used in refractory applications where heat absorption and chemical stability are critical.

The term “refractory dust” in the description should be understood as a specific embodiment of a refractory material comprising primarily silica-based and zirconia-based compounds. The refractory dust is thermally stable, chemically inert, and structurally durable under elevated temperatures. In some embodiments, the refractory dust is formed as a byproduct of an investment casting process.

The terms “sorption,” “sorbent capacities,” and “sorbency” in the description should be understood as the process by which a liquid substance attaches to another material. It encompasses both “absorption,” defined as the process by which a liquid substance penetrates into the inner structure of a material, and “adsorption,” defined as the process by which a liquid substance adheres to the surface of a material

The term “neutralizer” in the description should be understood as a powdered, solid, or liquid substance that increases or decreases the pH of another substance towards chemical neutrality, or a pH of 7. “Acid neutralizers” may be suited to neutralize acidic substances, and “base neutralizers” may be suited to neutralize basic or alkaline substances. “Universal neutralizers,” meanwhile, have the capabilities of both acid and base neutralizers.

The term “thermal runaway” in the description should be understood as an uncontrollable, self-heating state within a lithium-ion battery resulting in extremely high temperatures. Batteries experiencing thermal runaway events can threaten anything contacting or surrounding them. A “non-venting” or “non-explosive” event of thermal runaway refers to when a battery experiences an intense temperature rise without fully igniting or exploding. In a non-venting event, the toxic and flammable gases encased by a battery are not released. In the opposite case, a “venting” event of thermal runaway refers to when batteries aggressively vent toxic and flammable gases, possibly igniting surroundings. More broadly, “venting forces” can refer to any similar forces to those occurring in venting events. Specifically, such venting forces may displace objects via aggressive airflow.

### I. Material Composition

Refractory materials 100 disclosed herein comprise an engineered composition with specific molecular compounds and phases to balance heat resistance and chemical inertness suitable for advanced safety applications. In particular, refractory materials 100 comprise mineral-based compounds, commonly classified according to their principle chemical constituents into categories including, but not limited to, silica-based, zircon-based, alumina-based compounds, or combinations thereof. Each of these compounds can be further categorized into distinct phases, each defined by unique crystalline structures and corresponding thermal and chemical properties.

Refractory materials 100 according to the present invention can be used in formulations to control elevated temperatures of goods and/or a sorption agent. The formulations of refractory materials 100 prevent clumping during use a sorption agent. While refractory materials 100 may be categorized by their primary chemical base, many formulations also incorporate various synergistic oxides to enhance performance. These may include silica (SiO₂), zirconia (ZrO₂), alumina (Al₂O₃), magnesium oxide (MgO), sodium oxide (Na₂O), calcium oxide (CaO), hafnia (HfO₂), and any combination thereof. Together, these oxides form a robust matrix that resists deformation, absorbs and dissipates heat efficiently, and remains chemically stable when exposed to a wide range of reactive liquids. Thus, the refractory materials perform reliably in extreme industrial and safety-critical applications.

Refractory materials 100 comprise a dry weight and a specific refractory material composition of oxides based on the dry weight. Specifically, refractory materials 100 comprise a silica content between 30.0 wt. % and 100.0 wt. %, a zirconia content between 0.00 wt. % and 70.0 wt. %, an alumina content between 0.00 wt. % and 70.0 wt. %, a magnesium oxide content between 0.00 wt. % and 10.0 wt. %, a sodium oxide content between 0.00 wt. % and 10.0 wt. %, calcium oxide content between 0.00 wt. % and 5.00 wt. %, and a hafnia content between 0.00 wt. % and 5.00 wt. %. Refractory materials 100 may comprise additional oxides in trace amounts to achieve the desired thermal, chemical, and mechanical properties. For example, the refractory material 100 may further comprise oxides and/or elements including silver(I) oxide (Ag₂O), americium(III) oxide (Am₂O₃), argon (Ar), barium oxide (BaO), ceria (CeO₂), cobalt(II, III) oxide (Co₃O₄), chromic oxide (Cr₂O₃), cupric oxide (CuO), erbium(III) oxide (Er₂O₃), ferric oxide (Fe₂O₃), germanium(IV) oxide (GeO₂), potassium oxide (K₂O), manganous oxide (MnO), manganic oxide (Mn₂O₃), molybdic oxide (MoO₃), neodymium(III) oxide (Nd₂O₃), nickelous oxide (NiO), osmium(VIII) oxide (OsO₄), phosphorus(V) oxide (P₂O₅), palladous oxide (PdO), rhodium(III) oxide (Rh₂O₃), ruthenium(VIII) oxide (RuO₄), sulfur(VI) oxide (SO₃), strontium oxide (SrO), titania (TiO₂), uranium(VI, V) oxide (U₃O₈), vanadium(V) oxide (V₂O₅), yttria (Y₂O₃), ytterbia (Yb₂O₃), zinc oxide (ZnO), or any combination thereof.

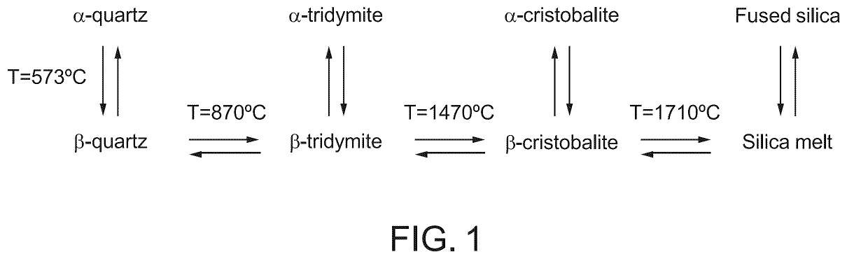

Additionally, the refractory materials 100 comprise various phase compositions that improve thermal stability, mechanical strength, and chemical resistance. The various phase compositions include silica, zircon, zirconia, alumina, magnesia, carbide phases, or any combination thereof. Each elemental category can exhibit multiple distinct phases, characterized by variations in crystalline structure, material stability, internal porosity, thermal insulation properties, and sorbent capacity. For example, silica comprises quartz, tridymite, cristobalite, and fused silica phases, distinguished by their temperature stability and physical properties (see FIG. 1). Specifically, quartz comprises a trigonal or hexagonal crystalline structure and remains stable at temperatures up to 870 degrees Celsius. Tridymite comprises an orthombic or hexagonal crystalline structure and remains stable at temperatures up to 1470 degrees Celsius, Cristobalite comprises a tetragonal or cubic crystalline structure and remains stable at temperatures up to 1710 degrees Celsius. Fused silica comprises an amorphous, non-crystalline structure and remains stable at temperatures above 1710 degrees Celsius. Refractory materials 100 may comprise specific amounts of various phases within each elemental category, such as quartz and cristobalite. Refractory materials 100 that comprise silica-based compounds, wherein at least 97.000 wt. % of the silica content is in the cristobalite phase, are Ceramic Shell Material (hereafter referred to as “CSM”), described in greater detail below. Refractory materials 100 that comprise silica-based compounds, wherein at least 97.000 wt. % of the silica content is a blend of the cristobalite phase and the fused silica phase, are Combined Ceramic Shell Material (hereafter referred to as “Combined CSM”).

In an exemplary embodiment, the refractory material 100 is CSM, formed of silica-based compounds and comprising the composition of oxides described above. Silica and the above-described oxides increase the effective material density of the CSM. Further, the silica-based compounds of the CSM comprise a dry weight and a specific distribution of the oxides measured relative to the dry weight. The specific distribution of the oxides, described in greater detail below, makes the CSM thermally stable, chemically inert, and structurally durable under elevated temperatures.

CSM can comprise silica having a silica content between 70.0 wt. % and 97.0wt. % to present more hydrophilic bonding sites and increase liquid adsorption. In some embodiments, the silica content is between 70.0 wt. % and 72.7 wt. %, 72.7 wt. % and 75.4 wt. %, 75.4 wt. % and 78.1 wt. %, 78.1 wt. % and 80.8 wt. %, 80.8 wt. % and 83.5 wt. %, 83.5 wt. % and 86.2 wt. %, 86.2 wt. % and 88.9 wt. %, 88.9 wt. % and 91.6 wt. %, 91.6 wt. % and 94.3 wt. %, or between 94.3 wt. % and 97.0 wt. %. The high silica content enhances thermal resilience by maintaining structural integrity at elevated temperatures. Further, a high silica content increases the density of surface silanol (Si—OH) groups, which actively attract and bind polar molecules, and siloxane bridges (OH—Si—OH), which attract and bind nonpolar molecules. Each CSM particle comprises distinct hydrophilic surface regions and pores devoid of siloxane bridges and hydrophobic surface regions and pores devoid of silanol groups, as described in further detail below.

CSM can further comprise zirconia having a zirconia content between 1.00 wt. % and 7.00 wt. % to increase mechanical strength and thermal shock resistance. In some embodiments, the zirconia content is between 1.00 wt. % and 1.50 wt. %, 1.50 wt. % and 2.00 wt. %, 2.00 wt. % and 2.50 wt. %, 2.50 wt. % and 3.00 wt. %, 3.00 wt. % and 3.50 wt. %, 3.50 wt. % and 4.00 wt. %, 4.00 wt. % and 4.50 wt. %, 4.50 wt. % and 5.00 wt. %, 5.00 wt. % and 5.50 wt. %, 5.50 wt. % and 6.00 wt. %, 6.00 wt. % and 6.50 wt. %, or between 6.50 wt. % and 7.00 wt. %. Zirconia additionally comprises surface hydroxyl (—ZrOH) groups that similarly bind water to surface silanol groups, as described above.

CSM can comprise alumina having an alumina content between 1.00 wt. % and 5.00 wt. % to improve hardness, wear resistance, thermal conductivity, and stability under oxidative conditions. In some embodiments, the alumina content is between 1.00 wt. % and 1.50 wt. %, 1.50 wt. % and 2.00 wt. %, 2.00 wt. % and 2.50 wt. %, 2.50 wt. % and 3.00 wt. %, 3.00 wt. % and 3.50 wt. %, 3.50 wt. % and 4.00 wt. %, 4.00 wt. % and 4.50 wt. %, or between 4.50 wt. % and 5.00 wt. %.

CSM can comprise magnesium oxide having a magnesium oxide content between 0.100 wt. % and 0.500 wt. % to increase the thermal conductivity and melting point, which better dissipates heat and resists thermal shock. In some embodiments, the magnesium oxide content is between 0.100 wt. % and 0.150 wt. %, 0.150 wt. % and 0.200 wt. %, 0.200 wt. % and 0.250 wt. %, 0.250 wt. % and 0.300 wt. %, 0.300 wt. % and 0.350 wt. %, 0.350 wt. % and 0.400 wt. %, 0.400 wt. % and 0.450 wt. %, or between 0.450 wt. % and 0.500 wt. %.

CSM can comprise sodium oxide having a sodium oxide content between 0.100 wt. % and 0.700 wt. % to enhance structural cohesion. In some embodiments, the sodium oxide content is between 0.100 wt. % and 0.150 wt. %, 0.150 wt. % and 0.200 wt. %, 0.200 wt. % and 0.250 wt. %, 0.250 wt. % and 0.300 wt. %, 0.300 wt. % and 0.350 wt. %, 0.350 wt. % and 0.400 wt. %, 0.400 wt. % and 0.450 wt. %, 0.450 wt. % and 0.500 wt. %, 0.500 wt. % and 0.550 wt. %, 0.550 wt. % and 0.600 wt. %, 0.600 wt. % and 0.650 wt. %, or between 0.650 wt. % and 0.700 wt. %.

CSM can comprise calcium oxide having a calcium oxide content between 0.010 wt. % and 0.100 wt. % to provide a level of alkalinity that buffers acidic environments and remains durable in corrosive settings. In some embodiments, the calcium oxide content is between 0.010 wt. % and 0.020 wt. %, 0.020 wt. % and 0.030 wt. %, 0.030 wt. % and 0.040 wt. %, 0.040 wt. % and 0.050 wt. %, 0.050 wt. % and 0.060 wt. %, 0.060 wt. % and 0.070 wt. %, 0.070 wt. % and 0.080 wt. %, 0.080 wt. % and 0.090 wt. %, or between 0.090 wt. % and 0.100 wt. %.

CSM can comprise hafnia having a hafnia content between 0.010 wt. % and 0.100 wt. % to increase thermal stability and decrease thermal conductivity in the refractory material under high temperature conditions. In some embodiments, the hafnia content is between 0.010 wt. % and 0.020 wt. %, 0.020 wt. % and 0.030 wt. %, 0.030 wt. % and 0.040 wt. %, 0.040 wt. % and 0.050 wt. %, 0.050 wt. % and 0.060 wt. %, 0.060 wt. % and 0.070 wt. %, 0.070 wt. % and 0.080 wt. %, 0.080 wt. % and 0.090 wt. %, or between 0.090 wt. % and 0.100 wt. %.

CSM can additionally comprise trace amounts of silver(I) oxide (Ag₂O), americium(III) oxide (Am₂O₃), argon (Ar), barium oxide (BaO), ceria (CeO₂), cobalt(II, III) oxide (Co₃O₄), chromic oxide (Cr₂O₃), cupric oxide (CuO), erbium(III) oxide (Er₂O₃), ferric oxide (Fe₂O₃), germanium(IV) oxide (GeO₂), potassium oxide (K₂O), manganous oxide (MnO), manganic oxide (Mn₂O₃), molybdic oxide (MoO₃), neodymium(III) oxide (Nd₂O₃), nickelous oxide (NiO), osmium(VIII) oxide (OsO₄), phosphorus(V) oxide (P₂O₅), palladous oxide (PdO), rhodium(III) oxide (Rh₂O₃), ruthenium(VIII) oxide (RuO₄), sulfur(VI) oxide (SO₃), strontium oxide (SrO), titania (TiO₂), uranium(VI, V) oxide (U₃O₈), vanadium(V) oxide (V₂O₅), yttria (Y₂O₃), ytterbia (Yb₂O₃), and zinc oxide (ZnO).

The silica-based compounds of CSM exist predominantly in the cristobalite phase, as described above. Cristobalite is a high-temperature polymorph of silica comprising strong silicon-oxygen bonds that remain stable under thermal conditions up to 1710 degrees Celsius, as shown in FIG. 1. As such, cristobalite comprises a high melting point and low thermal expansion. Further, the present cristobalite materials of CSM comprise both α-cristobalite and metastable β-cristobalite phases, creating structural irregularities and internal porosity that enhance thermal insulation and sorbent capacity. When accounting for present silica phases of the refractory material 100, cristobalite comprises a cristobalite content between 48.000 wt. % and 99.900 wt. % of the total silica content. In some embodiments, the cristobalite content is between 97.000 wt. % and 99.900 wt. % of the total silica content. In some embodiments, the cristobalite content is between 97.000 wt. % and 97.290 wt. %, 97.290 wt. % and 97.580 wt. %, 97.580 wt. % and 97.870 wt. %, 97.870 wt. % and 98.160 wt. %, 98.160 wt. % and 98.450 wt. %, 98.450 wt. % and 98.740 wt. %, 98.740 wt. % and 99.030 wt. %, 99.030 wt. % and 99.320 wt. %, 99.320 wt. % and 99.610 wt. %, or between 99.610 wt. % and 99.900 wt. %.

The silica-based compounds of Combined CSM, on the other hand, can comprise a blend of the cristobalite and fused silica phases to improve thermal stability. The Combined CSM comprises a fused silica to cristobalite ratio between 0.01 and 1.00. In some embodiments, the fused silica to cristobalite ratio is between 0.01 and 0.10, 0.10 and 0.20, 0.20 and 0.30, 0.30 and 0.40, 0.40 and 0.50, 0.50 and 0.60, 0.60 and 0.70, 0.70 and 0.80, 0.80 and 0.90, or between 0.90 and 1.00.

Further, the silica-based compounds of CSM comprise only trace amounts of the quartz phase to enhance structural diversity of the material without compromising core performance. Quartz comprises a dense trigonal crystalline structure, improving material rigidity of the CSM. This trigonal structure, however, is prone to thermal expansion, causing stress and cracking under heat. A significantly lower concentration of quartz compared to cristobalite advantageously preserves thermal stability, heat resistance, and electrical nonconductivity of the refractory material. While all phases of silica are substantially non-conductive at room temperature (˜22 degrees Celsius), silica becomes increasingly semiconductive at higher temperatures and becomes completely conductive when liquified. At those higher temperatures, the silica phases are both conductive enough to complete a circuit and resistive enough to generate high temperatures capable of liquifying surrounding silica and catalyzing a harmful chain reaction. Conventional silica materials comprising a silica phase less than 97.000% cristobalite, for example, will have lower melting points and thus greater potential of accelerating a harmful electrical runaway reaction. The refractory material 100 of the present application, comprising a 97.000 wt. % to 99.900 wt. % cristobalite phase concentration, may be maintained at temperatures above 1710 Celsius to potentially liquify and catalyze a cascade reaction. Therefore, the high cristobalite concentration allows the refractory material 100 to comprise a greater heat resistance than conventional silica materials, thereby preventing electrical conductivity and harmful chain reactions.

The CSM includes additional oxides and elements, such as zircon and alumina, with additional phases that are thermally stable, chemically inert, and structurally durable under elevated temperatures. For example, CSM comprises a zircon phase comprising a zircon phase content between 0.000 wt. % and 35.00 wt. %. In some embodiments, the zircon wt. % can range between 0.000 wt. % and 3.500 wt. %, 3.500 wt. % and 7.000 wt. %, 7.000 wt. % and 10.500 wt. %, 10.500 wt. % and 14.00 wt. %, 14.00 wt. % and 17.50 wt. %, 17.50 wt. % and 21.00 wt. %, 21.00 wt. % and 24.500 wt. %, 24.50 wt. % and 28.00 wt. %, 28.00 wt. % and 31.50 wt. %, or between 31.50 wt. % and 35.00 wt. %.

CSM additionally comprises an alumina phase of mullite comprising a mullite content of 10.00 wt. % to 40.00 wt. % to improve thermal stability and decrease thermal expansion. In some embodiments, the mullite content can range between 10.00 wt. % and 13.00 wt. %, 13.00 wt. % and 16.00 wt. %, 16.00 wt. % and 19.00 wt. %, 19.00 wt. % and 22.00 wt. %, 22.00 wt. % and 25.00 wt. %, 25.00 wt. % and 28.00 wt. %, 28.00 wt. % and 31.00 wt. %, 31.00 wt. % and 34.00 wt. %, 34.00 wt. % and 37.00 wt. %, or between 37.00 wt. % and 40.00 wt. %.

Further, CSM comprises trace amounts of phases including, but not limited to, chromium, silicon, corundum, amorphous silica, baddeleyite, vlasovite, sodium zirconium and silicate.

The oxides, in combination with the phase concentrations, give the CSM a robust and chemically resilient refractory material composition. Each oxide and phase contributes distinct advantages, such as thermal stability, corrosion resistance, mechanical strength, and low thermal expansion, that collectively enhance the extreme environment performance of the refractory material.

### II. Material Structure

In addition to the material composition, the refractory material 100 comprises a specific physical structure enabling liquid sorption and thermal insulation. For example, refractory materials 100 comprise a porous structure integrated with rigid crystalline lattices. The porous network minimizes thermal conductivity and facilitates the sorption and retention of polar and non-polar liquids, while the crystalline lattice provides structural rigidity. This combination allows refractory materials to perform effectively in environments demanding both fluid management and heat resistance.

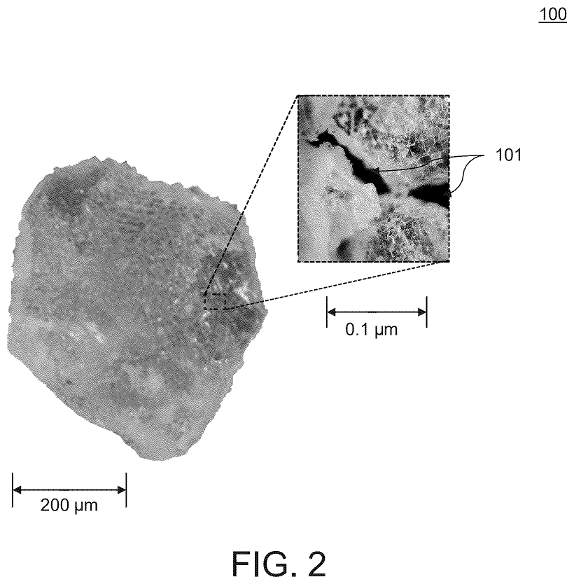

In an exemplary refractory material embodiment, CSM comprises a porous structure, as shown in FIG. 2, that maximizes surface area and fluid interaction. This porous construction is formed through a combination of thermal activation and gas evolution during material heating and cooling. As the silica matrix undergoes phase transitions, escaping gases exert pressure that generates cracks, cavities, and a network of pores 101 in each CSM particle. This transformation yields a high internal surface area for improved capillary action and molecular diffusion. Furthermore, the pores 101 comprise micropore diameters ranging from micropores (pore diameter of less than 2 nm) to macropores (pore diameter between 50 nm and 1000 nm), allowing effective sequestration of a wide range of molecule sizes. Therefore, the pores 101 trap liquid and heat to dramatically slow evaporation and suppress convection. Collectively, these structural features enable the refractory material 100 to achieve superior thermal and fluid management performance under demanding conditions.

The network of pores 101 dramatically increase the internal surface area of the CSM, enhancing both capillary action and molecular interaction. Specifically, the pores 101 generate a strong pressure gradient that draws both polar and nonpolar liquids deeper and more rapidly into the CSM via intensified capillary forces. This effect is further amplified by the distribution of concentrated hydrophobic and hydrophilic activity sites across the silica surface. In particular, a single particle of CSM may comprise distinct surface regions with hydrophilic properties (having surface silanols) or hydrophobic properties (devoid of surface silanols). This enables the CSM to function as a sorbent for both polar and non-polar substances, such as water-and oil-based compounds. Additionally, the CSM can sorb the polar and non-polar substances from a variety of spill sites including, but not limited to, concrete, tile, hardwood, laminate, fabric, vinyl, linoleum, asphalt, gravel, sand, grass, turf, brick, soil, or any combination thereof. Together, the pore geometry and silica surface chemistry promote efficient liquid adsorption. Moreover, the confined pore structure and strong surface adhesion significantly inhibit the escape or evaporation of adsorbed liquids, ensuring prolonged retention within the CSM.

The pores 101 of the silica matrix further trap air and disrupt heat flow to improve the thermal insulation of the CSM. The porous structure minimizes conduction and suppresses convection. Furthermore, the CSM allows heat to permeate through its mass, preventing heat reflection back to the source. Specifically, the pores 101 (ranging from micropores to macropores) minimize conduction by creating a discontinuous solid framework, where limited contact points between silica particles impede the direct flow of thermal energy. Simultaneously, the small pore diameters suppress convention by restricting fluid movement and preventing the formation of heat-carrying air currents. As a result, hot air filters gradually through the matrix, distributing heat away from the source. This controlled airflow reduces both conductive and convective heat transfer, while also retaining gases and vapors within the material.

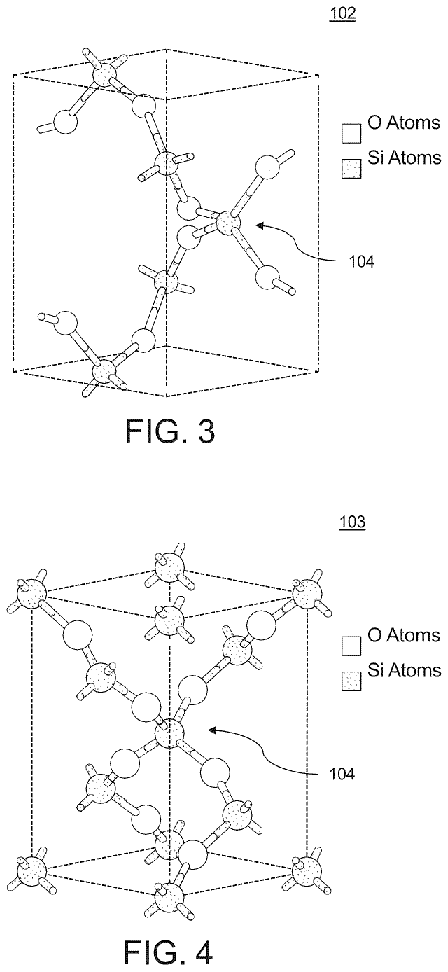

CSM has crystalline lattice structures 102, 103 that reinforce the silica matrix and enhance both sorbent capacity and thermal insulation. The cristobalite of CSM forms a tightly bonded framework of stable α-particles with tetragonal crystalline lattice 102, as shown in FIG. 3, and metastable β-particles with cubic crystalline lattice 103, as shown in FIG. 4, comprising repeating SiO₄ bonds 104. These bonds 104 are tightly packed, thereby increasing CSM's material density. The atoms of the α-cristobalite tetragonal lattice 102 are spread out, allowing greater flowability of liquids through the silica matrix. On the other hand, the atoms of the metastable β-cristobalite cubic lattice 103 are more closely connected together, increasing liquid retention and preventing heat transfer through the silica matrix. Further, this rigid three-dimensional framework resists compression and distortion, even under high temperatures. Compared to other silica phases, such as quartz, the cristobalite lattice structures 102, 103 comprise a more open and flexible structure that absorbs thermal vibrations without collapsing. This structural resilience further preserves the high internal surface area of the silica matrix, necessary for capillary action and thermal insulation.

The cristobalite lattice structures 102, 103 also contribute directly to adsorption and insulation. Cristobalite comprises hydrophilic silanol groups that promote adsorption of polar compounds as well as hydrophobic siloxane bridges that create binding sites for nonpolar compounds. The lattice structures 102, 103 further enhance surface chemistry, strengthening liquid interaction and retention. Meanwhile, the repetitive crystalline lattice structures 102, 103 disrupt heat flow, impede thermal transfer, and break conduction pathways. Together, these molecular features enable cristobalite-phased silica to deliver superior performance in demanding thermal and fluid environments.

### III. Material Stability

Refractory material 100 is chemically inert, thermally resilient, and structurally durable. As described above, the porous structure and surface chemistry of the refractory material 100 adsorbs and retains liquids without degrading or reacting. Further, the refractory material 100 resists corrosion, maintains dimensional stability under heat, and suppresses heat flow through conduction and convection. Therefore, refractory material 100 performs reliably in applications that demand both thermal insulation and fluid management.

In an exemplary embodiment, CSM comprises a high cristobalite phase concentration that enhances thermal tolerance and insulation performance. Unlike other lower temperature silica phases, cristobalite comprises crystalline lattice frameworks 102, 103 creating a discontinuous solid framework, where limited contact points impede the direct flow of thermal energy. Thus, cristobalite remains stable at temperatures exceeding 1710 degrees Celsius (see FIG. 1), allowing the material to retain its shape and function during prolonged exposure to heat. CSM therefore prevents dangerous chain reactions that result from heat buildup, especially in packaging or containment systems. CSM is additionally nonreactive when exposed to a broad spectrum of substances, such as acids, bases, and neutral compounds. This chemical stability allows CSM to safely absorb corrosive liquids without degrading or releasing harmful byproducts.

Refractory materials 100 may also be processed into a variety of particle sizes without compromising their above-described thermal insulation and fluid containment performance. In particular, techniques such as controlled grinding or milling reduce the refractory material particle size without collapsing the rigid crystalline lattice structures 102, 103 or damaging the structure of the overall matrix. The crystalline lattice structures 102, 103 resist compression and distortion and thus, the refractory materials 100 retain their pore connectivity and surface chemistry even after size reduction. As such, the processed powders or granules continue to exhibit strong capillary action, liquid retention, and thermal insulation performance, making them suitable for applications that demand both lightweight handling and high-temperature reliability.

### IV. Refractory Material Particle Size

The refractory materials 100 described herein can comprise a particle size suited to a particular application. The refractory materials 100 can be provided as a block, powder, or any other suitable form. The particle size can be measured as the maximum diameter and further can be categorized as any of the following: ultra-fine, a fine powder or granule, particulate matter, a small pellet or grain, a medium-sized bead, or a larger structural element. For ultra-fine powders, the particle size can be between 0.001 mm to 0.01 mm. For a fine powder or granule, the particle size can be between 0.01 mm to 0.1 mm. For particulate matter, the particle size can be between 0.1 mm to 1 mm. For a small pellet or grain, the particle size can be between 1 mm to 10 mm range. For a medium-sized bead, the particle size can be between 10 mm to 50 mm. For a larger structural element, the particle size can be over 50 mm, limited only by the size of the production equipment.

### V. Refractory Material as an Additive

The material composition, structure, and stability, as highlighted above, make CSM highly effective as a refractory material additive to commercial spill control, fireproofing, and fire-extinguishing products. On their own, commercial products and neutralizers exhibit performance limitations. For example, commercial products may fail to provide adequate fire resistance or extinguishing capabilities, while some spill control and neutralization agents can inadvertently trigger hazardous or exothermic reactions when interacting with certain chemical substances. When combined with CSM, however, these commercial products achieve significantly improved performance, gaining enhanced fire-proofing and extinguishing capabilities while eliminating the risk of hazardous chemical or exothermic reactions. CSM's stability and universal sorption properties complement commercial products, creating a safer and more effective solution for spill control and fire mitigation.

As described above, CSM comprises a dense physical structure that increases its overall weight. CSM also comprises the network of pores 101 that decrease the material's effective density in air, but increase its effective density in liquids. This allows CSM to be more influenced by gravity than by viscosity or surface tension, enabling it to sink into liquid spills, adsorb the spilled liquid, resist sticking to the spill surface, and therefore easily clean off of the spill surface upon completely adsorbing the spilled liquid. In contrast, commercial products comprising much lower densities and weights are more affected by viscous and surface tension forces, preventing them from mixing and sorbing the spilled substance. This additionally causes the commercial products to adhere to the site of the spill and form a sludge-like residue that is difficult to clean. Blending CSM with lighter-weight commercial products, such as perlite or vermiculite significantly increases the functional density of the mixture, allows the commercial product to mix with the spill, and mitigates adhesion of the mixture to the site surface on which the spill occurred. CSM's porous structure also allows it to bind substances with jagged or irregular surface characteristics, thereby binding the commercial product particles together. This causes the commercial product particles to stick to themselves instead of the site of the spill without modifying their chemical properties or reducing their bonding sites. As a result, CSM in combination with other commercial products provides an improved blend that leaves less residue. This improves both the efficiency and cleanliness of spill remediation, explained in further detail below.

The higher density and weight of CSM further provides an advantage in environments where flame venting, air currents, or wind may be present. Unlike light-weight commercial fire-extinguishing and absorbent materials that can be easily blown away or scattered, CSM remains firmly in its intended place due to its gravitational stability. When blended with lighter-weight commercial products, such as perlite or vermiculite, CSM increases the density of the mixture, allowing the blend to resist displacement. This resistance not only improves safety but also reduces the need for repeated application or cleanup.

As additionally described above, CSM comprises chemically stable compounds with tightly bonded crystalline lattice frameworks that are non-reactive across all chemical environments (acids and bases, polar and nonpolar). This makes CSM a safe and inert choice for spill remediation, as further described below. When blended with commercial absorbents or neutralizers that may react with certain substances and cause dangerous exothermic reactions, CSM thermally buffers and physically stabilizes the mixture. Its non-reactive nature ensures that the overall blend remains chemically inert, preventing unwanted reactions, heat generation, or the formation or hazardous byproducts. This makes CSM-enhanced mixtures safer to use and allow for reliable cleanup without compromising chemical safety.

The composition, structure, and stability of refractory materials 100 support performance that reaches beyond conventional high temperature applications. These refractory materials 100 retain the microporous framework and crystalline lattice structure 102, 103 even after processing. Further, these refractory materials 100 function as effective additives, enhancing the performance and safety of commercial spill control, fireproofing, and fire-extinguishing products. These properties, therefore, support performance in applications beyond the conventional uses of refractory materials known to those skilled in the art. In some embodiments, for example, the refractory material 100 is embedded within packaging systems to provide thermal insulation, thermal protection, and liquid containment. In other embodiments, the refractory materials 100 are used for universal spill control enabling safe neutralization and/or cleanup of acids, bases, polar, nonpolar, and neutral chemicals, thereby reducing the risk of secondary exposure or airborne toxins. In other embodiments, the refractory material 100 demonstrates utility in components including, but not limited to, coatings and textiles. These applications demonstrate the material's versatility in managing thermal and chemical exposure beyond conventional refractory use.

### VI. Refractory Materials Packaging Applications

In packaging applications, the refractory materials 100 can mitigate and contain the adverse effects and hazards caused by unstable, energetic and/or flammable materials overheating, leaking, combusting, or exploding in shipment. In particular, refractory materials 100 are compatible with a wide range of chemicals and packaging materials and can both directly sorb excess heat or spilled material without modifying the surface chemistry of the packaging material. Additionally, the refractory materials 100 can enhance the ability of other materials to sorb excessive heat or spilled material present in the packaging without expanding in volume, losing structural integrity, igniting, breaking down, or producing harmful combustion products. Therefore, corrosive and reactive materials can be shipped in tight, uncontrolled shipping conditions without risks of damage to the package, adjacent shipping items, or the transport vehicle.

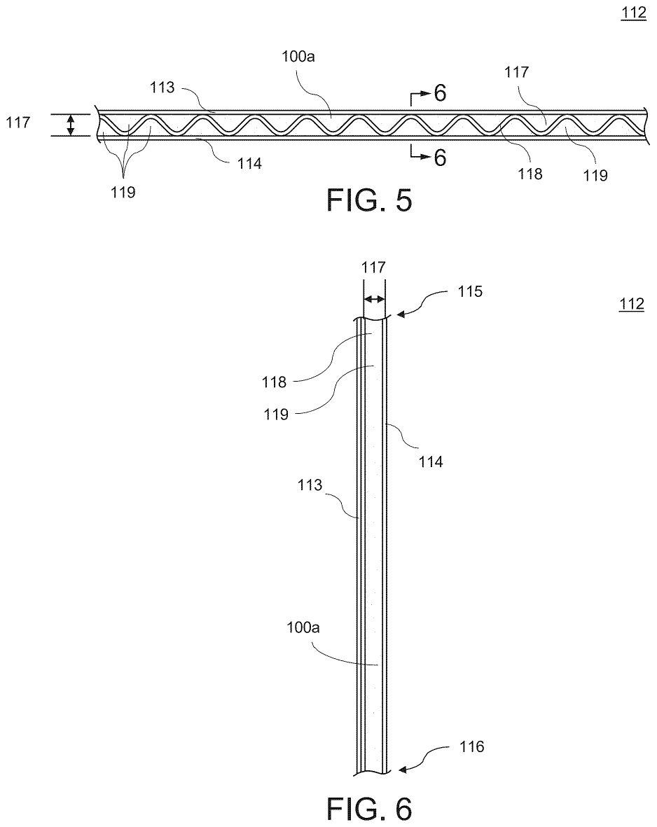

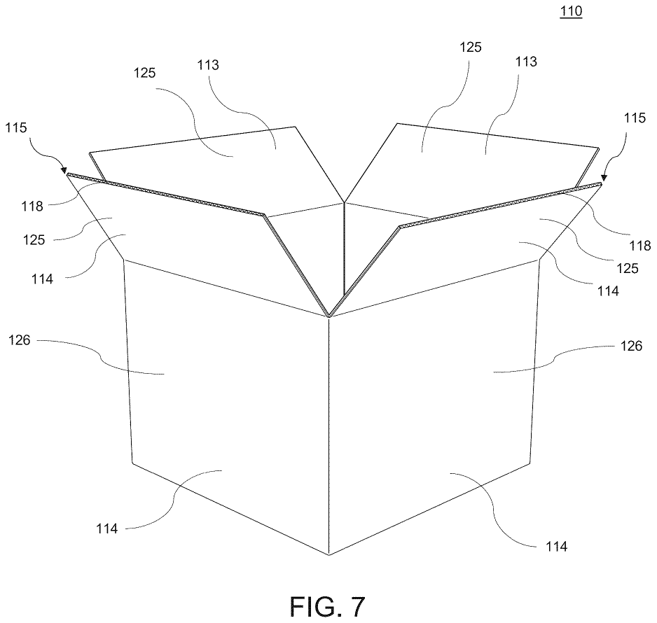

In some embodiments, the refractory materials 100 may be embedded within packaging 110 to prevent overheating, combusting, and liquid chemical leaks (see FIGS. 5 and 6). The packaging 110 may comprise a packaging material, including, but not limited to, cardboard, plastics, bio-plastics, metals, fiberglass, wood, fabrics, paper, or any other similar material. In such embodiments, as illustrated in FIGS. 7-10, the packaging 110 can comprise a plurality of panels 112. Each panel of the plurality of panels 112 can comprise an inner wall 113, an outer wall 114 opposite the inner wall 113, a receiving end 115, and a bottom end 116 opposite the receiving end 115. The inner wall 113 and outer wall 114 can be spaced to define an interior chamber 117. A corrugation 118 can be disposed within the interior chamber 117 and can be coupled to the inner wall 113 and the outer wall 114 to define a plurality of flutes 119. The corrugation 118 can extend an entire length (from the receiving end 115 to the bottom end 116) and width of each panel of the plurality of panels 112. In some embodiments, the corrugation 118 can be arranged in a serpentine shape. In alternative embodiments, however, the corrugation 118 can be arranged in a zigzag, honeycomb, square, rectangular, triangular, or any other suitable shape. During assembly, the receiving end 115 can communicate with a funnel through which a first refractory material 100a can be filled into the plurality of flutes 119. These first refractory material 100as, as described above, comprises material stability, nonconductivity, and heat-resistance, thereby allowing each filled panel of the plurality of panels 112 to resist damage in extreme conditions. Both the receiving end 115 and the bottom end 116 can be capped or sealed to ensure that the first refractory material 100a remains within the interior chamber 117 during transit. The configuration of the corrugation 118 and the plurality of flutes 119 can allow the packaging 110 to maintain its original material-specific flexibility and/or durability and provide pockets for receiving the first refractory material 100a. In order to properly receive the first refractory material 100a and maintain the structure of each panel, each flute of the plurality of flutes 119 comprises a particular flute volume. As the first refractory material 100a is poured into each flute, a vibratory element is attached to each panel to facilitate flowability and evenly distribute the first refractory material 100a throughout the interior chamber 117 of the packaging 110. Upon filling the entire flute volume, the receiving end 115 is sealed.

Once the evenly distributed first refractory material 100a has been sealed within the packaging corrugation 118, the plurality of panels 112 forming the packaging 110 can be assembled and shaped as desired. For example, the packaging 110 may be shaped into a square-shaped box, a rectangular-shaped box, a cylindrical tube, an envelope, or any suitable packaging configuration. The packaging shaping is described in further detail below.

By encasing the first refractory material 100a within the corrugation 118 (see FIGS. 5 and 6) of each panel, the first refractory material 100a can absorb any excess heat/liquid that may be generated by packaging corrosive, reactive, or flammable materials. Such materials may include, but are not limited to, lithium-ion batteries, charged capacitors, munitions, sulfuric acid, nitric acid, concentrated acetic acid, hydrochloric acid, sodium hydroxide, or hydrogen peroxide. As shown in Example 2 below, materials containing refractory materials were able to withstand both vented and non-venting simulated emergencies. The first refractory material 100a absorbs the excess heat and/or spilled liquid within the packaging 110 without reacting or expanding in volume, thereby mitigating stresses applied to the packaging 110. As such, the plurality of panels 112 filled with the first refractory material 100a are particularly useful for packaging corrosive, sensitive, and reactive materials such as lithium-ion batteries where damage to its encasement can ruin its functionality. Additionally, the first refractory material 100a may significantly delay or reduce thermal damage and fire-related degradation in each panel of the plurality of panels 112, because of their ability to withstand maintained temperatures of up to 1710 degrees Celsius without melting, becoming conductive, and potentially accelerating a harmful cascade reaction in the shipping materials. Furthermore, the first refractory material 100a can mitigate exothermic reactions generated by spilled acids and bases, providing enhanced protection to both the packaging 110 and its surroundings.

The first refractory material 100a can be any refractory material that comprises thermal resistance and sorbency to allow each panel of the plurality of panels 112 to resist damage in extreme conditions. In some embodiments, the first refractory material 100a is CSM. When disposed in the corrugation 118, CSM can efficiently adsorb spilled liquid and prevent heat transfer through conduction and convection. Specifically, CSM can absorb excess heat present in the packaging without melting, becoming conductive, and potentially accelerating a harmful cascade reaction in the shipping materials due to the fact that 97.000 wt. %-99.900 wt. % of the silica within the CSM is in the cristobalite phase, providing the material with stability, nonconductivity, and heat resistance properties, as explained above. Therefore, the inner and outer walls 113, 114 surrounding the disposed CSM would need to reach and maintain temperatures above 1710 degrees Celsius before the cristobalite of the CSM would liquify and potentially catalyze a cascade reaction. In other embodiments, the first refractory material 100a can be other thermally resistant and sorbent refractory materials including, but not limited to, Combined CSM, compounds with a silica content of 100 wt. %, all of which in the fused silica phase (hereafter referred to as “fused silica”), zircon sand, refractory dust, or any combination thereof.

The first refractory material 100a comprises a first particle size selected to facilitate flowability into the plurality of flutes 119, allowing each flute to be densely and uniformly filled. This ensures maximal contact between the refractory material particles and each flute to enhance the thermal resistance and sorbency of the packaging 110. In some embodiments, as introduced above, the first refractory material 100a comprises a first particle size between 0.001 mm and 0.010 mm. In some embodiments, the first particle size is between 0.001 mm and 0.002 mm, 0.002 mm and 0.003 mm, 0.003 mm and 0.004 mm, 0.004 mm and 0.005 mm, 0.005 mm and 0.006 mm, 0.006 mm and 0.007 mm, 0.007 mm and 0.008 mm, 0.008 mm and 0.009 mm, or between 0.009 mm and 0.010 mm. In other embodiments, the first particle size can be between 0.010 mm and 0.100 mm. In some embodiments, the first particle size can be between 0.010 mm and 0.020 mm, 0.020 mm and 0.030 mm, 0.030 mm and 0.040 mm, 0.040 mm and 0.050 mm, 0.050 mm and 0.060 mm, 0.060 mm and 0.070 mm, 0.070 mm and 0.080 mm, 0.080 mm and 0.090 mm, or between 0.090 mm and 0.100 mm.

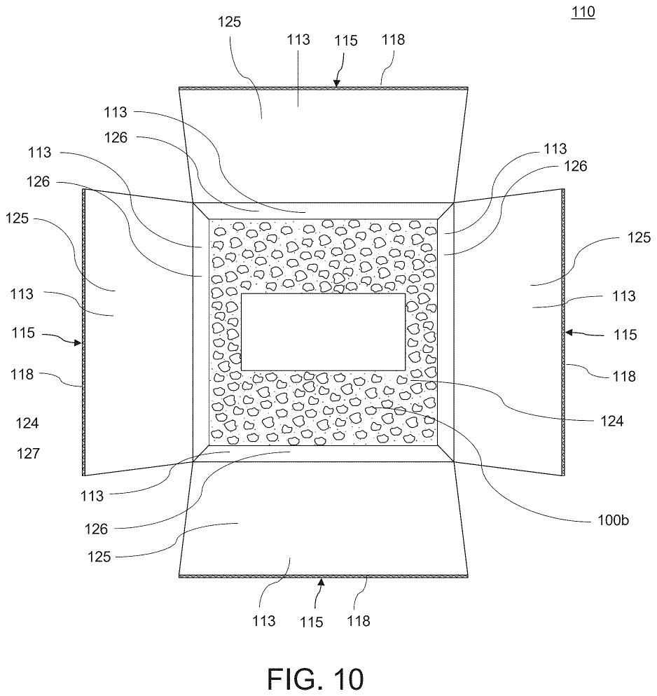

In some square and rectangular-shaped box embodiments, as shown in FIG. 7, the packaging 110 can comprise at least one base panel 124, at least one top panel 125 opposite the base panel 124 and at least one side panel 126, configured to enclose corrosive, reactive, and/or flammable materials. The base panel 124, the at least one top panel 125, and the at least one side panel 126 can communicate together to form an enclosed space 127. In one embodiment, as shown in FIG. 10, a second refractory material 100b can be placed within the enclosed space 127 to prevent the overheating and combusting of reactive material leaks. This can be in addition to or instead of the first refractory material 100a disposed within the base panel 124, the at least one top panel 125, and/or the at least one side panel 126 of the packaging 110. In some embodiments, the second refractory material 100b can be the same as the first refractory material 100a. In other embodiments, the second refractory material 100b is different from the first refractory material 100a. Furthermore, the second refractory material 100b comprises a second particle size. In some embodiments, the second particle size is the same as the first particle size. In other embodiments, the second particle size is greater than the first particle size. For example, the second particle size can be between 1 mm and 50 mm. In some embodiments, the second particle size is between 1 mm and 5 mm, 5 mm and 10 mm, 10 mm and 15 mm, 15 mm and 20 mm, 20 mm and 25 mm, 25 mm and 30 mm, 30 mm and 35 mm, 35 mm and 40 mm, 40 mm and 45 mm, or between 45 mm and 50 mm.

In other square and rectangular-shaped box embodiments, the packaging 110 is devoid of a top panel 125 and instead comprises a lid. The lid can comprise a first end and a second end opposite the first end. The inner packaging lid can be formed of at least one lid panel similar to the plurality of panels 112 described above. Specifically, the at least one lid panel can comprise a lid inner wall, a lid outer wall, a lid receiving end, a lid bottom end, a lid interior chamber, a lid corrugation, and a plurality of lid flutes filled with the first refractory material 100a. Once the evenly distributed first refractory material 100a has been sealed within the lid corrugation, the lid can be assembled and shaped to match the contours and be mechanically coupled to at least one side panel 126. In some embodiments, the lid may only extend along the length of the at least one side panel 126. In alternative embodiments, the lid may extend beyond the length of the at least one side panel 126 and be angled to extend at least partially along the length of at least one side panel 126. Additionally, the lid and the at least one side panel 126 can form a variety of mechanical locks to maintain a sealed packaging container configuration. For example, the at least one side panel and the lid may form an interference or press fit connection. In further embodiments, the at least one side panel and the lid may form a joint. Such joints may include, but are not limited to, fold joints, slot joints, tab joints, tab and slot joints, wedge joints, butt joints, mitered butt joints, dovetail joints and variations thereof, tongue and groove joints, dowel joints, biscuit joints, or any other suitable joint. In additional embodiments, the at least one panel and the lid may be screw fastened, adhered or form a snap fit, latch, sliding, joint, or any other suitable mechanical connection for sealing the enclosed space closed.

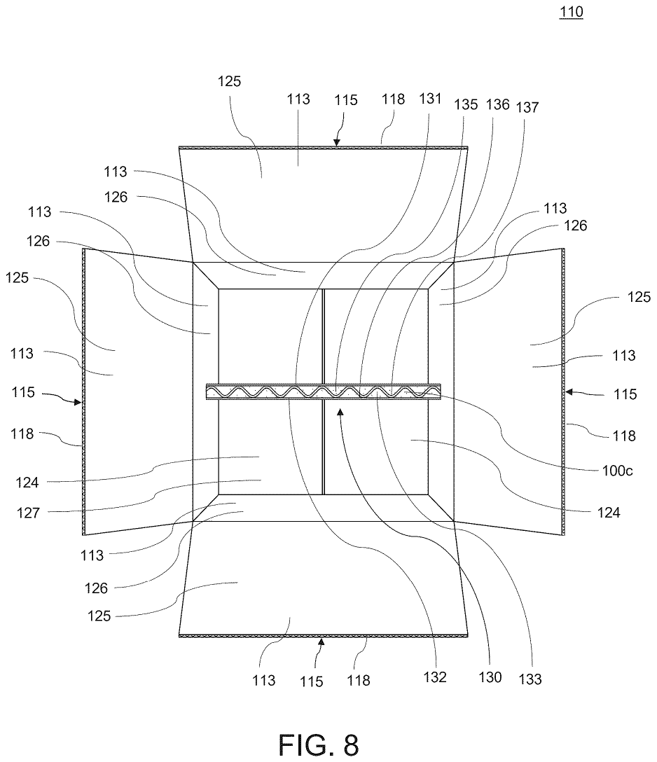

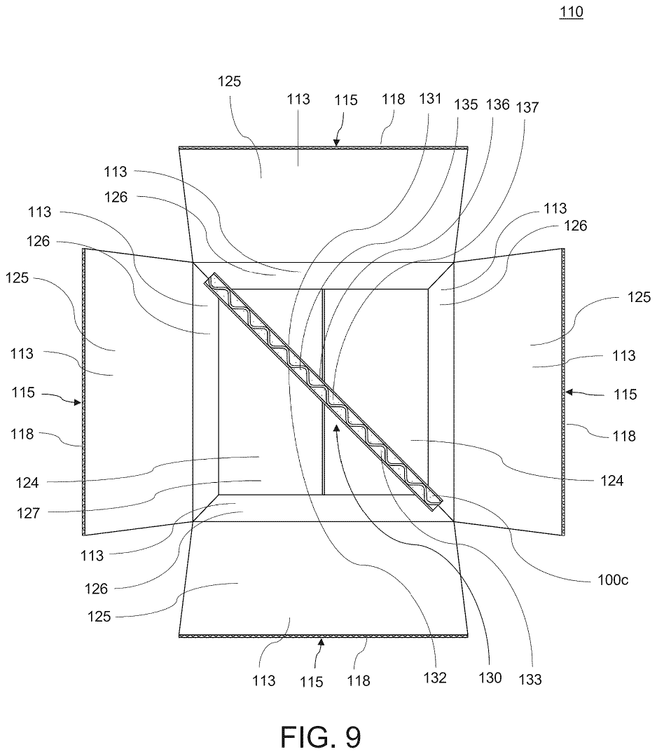

In further embodiments, the packaging 110 can comprise at least one divider panel 130, as shown in FIGS. 8 and 9, to separate adjacent corrosive, reactive, and/or flammable material item from one another in the enclosed space 127. The at least one divider panel 130 can comprise a divider material. The divider material may be formed from one of the following materials including, but not limited to, cardboard, plastics, bio-plastics, metals, fiberglass, wood, fabrics, paper, or any other similar material. The at least one divider panel 130 is configured similarly to each panel of the plurality of panels 112 (described above) to prevent the packaging 110 from overheating, combusting, and/or leaking reactive material. Specifically, the at least one divider panel 130 comprises a first divider panel wall 131, a second divider panel wall 132 opposite the first divider panel wall 131, a divider wall receiving end 133, and a divider wall bottom end 134 opposite the divider wall receiving end 133. The first divider panel wall 131 and second divider panel wall 132 can be spaced to define a divider panel interior chamber 135. The divider panel interior chamber 135 can define a divider panel corrugation 136. The first divider panel wall 131, second divider panel wall 132, and the divider panel corrugation 136 can corroborate to define a plurality of divider panel flutes 137. The divider panel corrugation 136 can extend an entire divider panel length (from the divider panel receiving end 133 to the divider panel bottom end 134) and divider panel width of the at least one divider panel 130. In some embodiments, the divider panel corrugation 136 can be arranged in a serpentine shape. In alternative embodiments, however, the divider panel corrugation 136 can be arranged in a zigzag, honeycomb, square, rectangular, triangular, or any other suitable shape. The divider panel receiving end 133 can be where the plurality of divider panel flutes 137 can receive a divider panel refractory material 100c via a funnel, either in addition to or instead of the first refractory material 100a being disposed within the at least one base panel 124, the at least one top panel 125, and/or the at least one side panel 126 of the packaging 110. This can also be in addition to or instead of the second refractory material 100b disposed within the enclosed space 127 of the packaging 110. Both the divider panel receiving end 133 and the divider panel bottom end 134 can be capped or sealed to ensure that the divider panel refractory material 100c remains within the divider panel interior chamber 135 during transit. In some embodiments, the divider panel refractory material 100c is the same as at least one of the first refractory material 100a and the second refractory material 100b. In other embodiments, the divider panel refractory material 100c is different from both the first refractory material 100a and the second refractory material 100b. Furthermore, the divider panel refractory material 100c comprises a third particle size. In some embodiments, the third particle size is the same as at least one of the first particle size and the second particle size. In other embodiments, the third particle size is different from both the first particle size and the second particle size. For example, the third particle size can be between 0.001 mm and 0.010 mm. In some embodiments, the third particle size is between 0.001 mm and 0.002 mm, 0.002 mm and 0.003 mm, 0.003 mm and 0.004 mm, 0.004 mm and 0.005 mm, 0.005 mm and 0.006 mm, 0.006 mm and 0.007 mm, 0.007 mm and 0.008 mm, 0.008 mm and 0.009 mm, or between 0.009 mm and 0.010 mm. In other embodiments, the third particle size can be between 0.010 mm and 0.100 mm. In some embodiments, the third particle size can be between 0.010 mm and 0.020 mm, 0.020 mm and 0.030 mm, 0.030 mm and 0.040 mm, 0.040 mm and 0.050 mm, 0.050 mm and 0.060 mm, 0.060 mm and 0.070 mm, 0.070 mm and 0.080 mm, 0.080 mm and 0.090 mm, or between 0.090 mm and 0.100 mm.

The at least one divider panel 130 can be configured to be positioned within packaging 110 comprising a variety of shapes and sizes. For example, the at least one divider panel 130 may sit within the enclosed space 127 of square/rectangular-shaped boxes, as shown in FIGS. 8 and 9, or in envelope-shaped packaging. In further embodiments, the divider panel 130 may extend between the base panel 124 and the at least one top panel 125, the base panel 124 and the at least one side panel 126, the at least one top panel 125 and at the least one side panel 126, or between any combination of the plurality of panels 112. The placement of the first refractory material 100a and divider panel refractory material 100c within the plurality of panels 112 and the at least one divider panel 130, can allow the packaging 110 to absorb excess heat and/or spilled liquid without expanding in volume or losing structural integrity. This property is especially useful for mitigating stresses applied to the outer encasement of packaging items packed in close proximity to one another. As specifically demonstrated by CSM embodiments, the high cristobalite concentration provides the disposed CSM with stability, nonconductivity, and heat resistance characteristics, and therefore allows the packaging to resist damage in extreme conditions.

Any one of the first, second, divider panel refractory materials 100a, 100b, 100c may be combined with a secondary material to sorb spilled liquids and heat and extinguish fire within or around the packaging 110. As such, the secondary material can be disposed within the plurality of flutes 119, the enclosed space 127, or the plurality of divider panel flutes 137. The secondary material can be any suitable commercial spill control, fireproofing, and/or fire-extinguishing product, such as perlite or vermiculite. Furthermore, the secondary material can comprise any suitable secondary material particle size. In embodiments in which the secondary material is disposed within the plurality of flutes 119, the secondary material particle size is the same as the first particle size. In other embodiments, the secondary material particle size is different from the first particle size. In embodiments in which the secondary material is disposed within the enclosed space 127, the secondary material particle size can be the same as the second particle size. In other embodiments, the secondary material particle size is different from the second particle size. In embodiments in which the secondary material is disposed within the plurality of divider panel flutes, the secondary material particle size is the same as the third particle size. In other embodiments, the secondary material particle size is different from the third particle size.

The material composition, structure, and stability, as highlighted above, make CSM highly effective as a refractory material additive to commercial spill control, fireproofing, and fire-extinguishing products. On their own, commercial products and neutralizers exhibit performance limitations. For example, commercial products may fail to provide adequate fire resistance or extinguishing capabilities, while some spill control and neutralizations agents can inadvertently trigger hazardous or exothermic reactions when interacting with certain chemical substances. When combined with CSM, however, these commercial products achieve significantly improved performance, gaining enhanced fire-proofing and extinguishing capabilities while eliminating the risk of hazardous chemical or exothermic reactions. CSM's stability and universal sorption properties complement commercial products, creating a safer and more effective solution for spill control and fire mitigation.

As described above, CSM comprises a dense physical structure that increases its overall weight. CSM also comprises the network of pores 101 that decrease the material's effective density in air, but increase its effective density in liquids. This allows CSM to be more influenced by gravity than by viscosity or surface tension, enabling it to sink into liquid spills, adsorb the spilled liquid, resist sticking to the spill surface, and therefore easily clean off of the spill surface upon completely adsorbing the spilled liquid. In contrast, commercial products comprising much lower densities and weights are more affected by viscous and surface tension forces, preventing them from mixing and sorbing the spilled substance. This additionally causes the commercial products to adhere to the site of the spill and form a sludge-like residue that is difficult to clean. When CSM is blended with these lighter-weight commercial products, such as perlite or vermiculite, it significantly increases the functional density of the mixture, allows the commercial product to mix with the spill, and removes the commercial product's tendency to stick to spill surfaces. CSM's porous structure also allows it to bind substances with jagged or irregular surface characteristics, thereby binding the commercial product particles together. This causes the commercial product particles to stick to themselves instead of the site of the spill without modifying their chemical properties or reducing their bonding sites. As a result, CSM in combination with other commercial products provides an improved blend that leaves less residue. This improves both the efficiency and cleanliness of spill remediation, explained in further detail below.

The higher density and weight of CSM further provides an advantage in environments where flame venting, air currents, or wind may be present. Unlike light-weight commercial fire-extinguishing and absorbent materials that can be easily blown away or scattered, CSM remains firmly in its intended place due to its gravitational stability. When blended with lighter-weight commercial products, such as perlite or vermiculite, CSM increases the density of the mixture, allowing the blend to resist displacement. This resistance not only improves safety but also reduces the need for repeated application or cleanup.

As additionally described above, CSM comprises chemically stable compounds with tightly bonded crystalline lattice frameworks that are non-reactive across all chemical environments (acids and bases, polar and nonpolar). This makes CSM a safe and inert choice for spill remediation, as further described below. When blended with commercial absorbents or neutralizers that may react with certain substances and cause dangerous exothermic reactions, CSM thermally buffers and physically stabilizes the mixture. Its non-reactive nature ensures that the overall blend remains chemically inert, preventing unwanted reactions, heat generation, or the formation or hazardous byproducts. This makes CSM-enhanced mixtures safer to use and allow for reliable cleanup without compromising chemical safety.

In even further embodiments, the inner and/or outer walls 113, 114 of the plurality of panels 112 can be coated with a coating material. The coating material can comprise a refractory material 100 and at least one auxiliary material. The auxiliary material can be paraffin wax, microcrystalline wax, soy wax, palm wax, ceresin wax, polyethylene wax, any other wax-like substance, or any combination thereof. In an exemplary embodiment, the refractory materials 100 can be combined with liquid paraffin wax to produce a wax coating that may be applied to the inner and/or outer walls 113, 114 of the plurality of panels 112. Wax-coated packaging can be particularly useful for shipping and containing perishable items such as food products. Specifically, wax-coated packaging can withstand high-moisture conditions by protecting shipping items from moisture in the environment, and by preventing wet shipping items from losing their moisture. However, conventional wax coating is highly flammable and thus can cause significant damage in shipment if exposed to excessive heat or fire. By combining the liquid wax with the refractory materials 100, the wax coating can take on the refractory materials'fire extinguishing properties to create safe, flame-resistant wax-coated packaging. Further, the refractory materials 100 do not contain any polyfluoroalkyl substances or PFAS. Instead, the refractory materials 100 are composed primarily of silica (a known food-safe product) and thus would not compromise the safety of any perishable edible products. In exemplary embodiments, the refractory materials 100 can combine with a paraffin-based liquid wax to produce the flame-resistant wax coating. Due to their hydrophobic surface regions and their particle size and shape, the refractory materials 100 can easily combine and evenly distribute throughout the liquid wax to produce a wax coating that comprises the flame-resistant and fire extinguishing properties of the refractory materials 100. Once the refractory materials 100 and the liquid wax are completely combined, the wax coating is poured into a wax distribution machine to evenly coat the inner and/or outer walls 113, 114 of the plurality of panels 112. Such machines could include, but are not limited to, a wax cascading machine, a curtain and roller application machine, or a curtain coater machine. The refractory material wax coating provides stability, nonconductivity, and heat resistance characteristics to the plurality of panels 112 and therefore can allow the packaging 110 to resist damage in extreme conditions. Therefore, perishable items can be safely shipped in insulated packaging 110 without risks of damage caused by uncontrolled shipping conditions.

### VII. Refractory Materials Spill Control and Self-Extinguishing Kit Applications

Refractory materials 100 can control spills and suppress fire. In spill control and self-extinguishing kit embodiments, the refractory materials 100 can sorb liquid chemical spills and extinguish contained fires to mitigate damage caused by corrosion, combustion, and harmful chain reactions. In particular, the refractory materials 100 may be safely poured onto areas affected by chemical spills due to their inherent chemical inertness, as described above. Once applied, the refractory materials 100 can be spread evenly across the area of the chemical spill to sorb the liquid without undergoing any chemical change or reaction, resulting in a mixture of refractory material and sorbed liquid that remains chemically stable. Furthermore, the mixture leaves less residue on the original spill surface and can be more easily and safely swept up and disposed of. Additionally, the refractory materials 100 may be poured onto a contained fire, where they absorb the heat and suppress combustion without reacting with the burning substances. The refractory materials 100 absorb thermal energy, they extinguish flames by disrupting heat transfer and forming a stable mixture of refractory material and cooled combustion byproducts. The resulting mixture leaves significantly less residue on the affected surface and may similarly be swept up and safely disposed of.

In exemplary spill control embodiments, CSM may be used on its own to safely adsorb spilled material without expanding in volume or catalyzing harmful reactions. As explained above, CSM comprises a unique cristobalite concentration (97.000 wt. %-99.900 wt. % of its crystalline silica in the cristobalite phase), porous structure, rigid crystalline lattice framework, and stability to adsorb acids, neutrals, and bases comprising polar and/or non-polar molecules. These features ensure chemical inertness and efficient adsorption of universal substances. Furthermore, CSM comprises sufficient density and weight, as explained above, allowing CSM to be more influenced by gravity than by viscosity or surface tension enabling the CSM to settle quickly and uniformly across the spill, as well as form a mixture with the sorbed liquid that leaves no residue on the spill surface. These combined properties make CSM well-suited for sorbing universal chemical spills, reducing cleanup time, and minimizing environmental or occupational hazards.

The unique physical structure of the CSM (solid crystals with porous air-filled passages throughout) means that they can remain lightweight in air, but once added to liquid their effective density becomes that of the liquid itself plus the mass of the solid crystal, allowing the low density powder to suddenly behave like an extremely dense particle once added to liquid.—The CSM can act like an anchor and carry the low-density particles attached to itself, through density and viscosity barriers it could never overcome on its own and making it truly self-mixing. Other high performance agents sit on the surface of a spill, absorbing from the top down (which is why their use instructions indicate that mixing is required) and substantially limiting their usefulness in applications which require them to be able to prevent a spill from moving in the direction of gravity (such as within a shipping container). This property (coupled with its inherent nature as a refractory material) also causes a sacrificial protective layer to form between the floor (or other surface, such as the bottom of a container) and the spill, providing a crucial means of mitigating heat buildup and chemical damage.

CSM may also be combined with at least one secondary commercial substance, such as perlite or vermiculite, in spill control applications. As explained above, commercial products comprise much lower densities and weights compared to CSM and therefore are more likely to adhere to the spill surface and form a sludge-like residue that is difficult to clean. When blended with these lighter-weight commercial products, CSM significantly increases the overall effective performance density of the mixture and mitigates the tendency to stick to spill surfaces. CSM additionally binds the commercial product particles together, causing them to stick to themselves instead of the spill surface. As a result, when the combined CSM and commercial product are poured onto a chemical spill, they form a stable mixture with the sorbed liquid that can be easily swept up and disposed of.

CSM can further be used in conjunction with acid, base, or universal neutralizers for alternative spill control applications. Acid neutralizers can comprise materials such as sodium bicarbonate, which reacts as a base and counteracts acid. Alternatively, base neutralizers can comprise acidic substances which counteract bases. Meanwhile, universal neutralizers can comprise amphoteric substances, which can react as either acid or base, or a blend of acids and bases or other similar chemicals. Universal neutralizers may be composed of magnesium oxide, magnesium hydroxide, other amphoteric materials, mixes of acids and bases, or combinations thereof. As described above, the application of neutralizers to spills may lead to exceedingly dangerous, reactive conditions. To mitigate this reactivity, commercial universal neutralization mixtures are typically concocted with universal neutralizer and an absorbent material, which is intended to both sorb the spill and moderate potentially dangerous reactions. However, these commercial neutralization mixtures may fail to properly neutralize substances because absorbent materials take up substances into their molecular structure. When an acid or base is retained within the molecular structure of an absorbent, the acid or base can no longer be neutralized. As a result, commercial neutralization mixtures are ineffective for neutralization of acids and bases and produce acidic and/or basic wastes when combined with too much absorbent. Alternatively, if not enough absorbent is provided within commercial neutralization mixtures, then they can still be susceptible to dangerous, exothermic reactions with acids and bases. Moreover, different types of spills may require different concentrations of neutralizer and absorbent, so one commercial neutralization mixture with a particular fixed ratio of neutralizer to absorbent is unlikely to be effective for spills of many different substances.

As an efficient and stable sorbent, CSM can be added or substituted for the absorbent to further stabilize neutralization reactions between universal neutralizers and acids or bases. CSM comprises enhanced material stability and thermal capacity over the absorbents indicated above, which can contribute to reducing the exothermic effects of neutralization reactions. CSM also differs from these absorbents because it comprises a high adsorptive capacity for both polar and nonpolar liquids. As such, CSM adheres acids or bases to its molecular surfaces without precluding them from further reaction. When applied to a spill of a substance with an unknown acid-base ratio, mixtures of CSM and universal neutralizer may therefore retain the spilled substance and stabilize the reaction of the substance and neutralizer without preventing any neutralization from occurring. Consequently, mixtures of CSM and universal neutralizer (hereafter “CSM-infused neutralizers”) improve safety and performance over conventional neutralization mixtures.

CSM-infused neutralizers, unlike conventional neutralization mixtures, may have a wide range of possible sorbent to neutralizer ratios suitable for neutralizing and stabilizing spills of varying acid-base ratio. CSM-infused neutralizers can comprise a CSM content of 0.05 wt. % and 75.0 wt. %. In some embodiments, the CSM content can range between 0.05 wt. % and 5.0 wt. %, 5.0 wt. % and 10.0 wt. %, 10.0 wt. % and 15.0 wt. %, 15.0 wt. % and 20.0 wt. %, 20.0 wt. % and 25.0 wt. %, 25.0 wt. % and 30.0 wt. %, 30.0 wt. % and 35.0 wt. %, 35.0 wt. % and 40.0 wt. %, 40.0 wt. % and 45.0 wt. %, 45.0 wt. % and 50.0 wt. %, 50.0 wt. % and 55.0 wt. %, 55.0 wt. % and 60.0 wt. %, 60.0 wt. % and 65.0 wt. %, 65.0 wt. % and 70.0 wt. %, or between 70.0 wt. % and 75.0 wt. %.

In exemplary self-extinguishing kit embodiments, CSM is used to safely extinguish contained fires. The high cristobalite concentration of CSM, combined with the high heat capacity, porous structure, rigid crystalline lattice framework, and thermal stability, cooperate to adsorb heat and suppress combustion. This provides CSM with chemical inertness and stability in the face of extreme environments. Furthermore, CSM comprises sufficient density and weight, as explained above, providing CSM with the gravitational stability to remain in an intended place even when flame venting or wind may be present. These combined properties make CSM well-suited for extinguishing fire and minimizing environmental or occupational hazards.

CSM may also be combined with at least one secondary commercial substance in fire-extinguishing applications. As explained above, light-weight commercial fire-extinguishing materials may be easily blown away or scattered. When CSM is blended with these materials, however, the mixture comprises an increased overall effective density with improved gravitational stability in the face of flame venting or wind. As a result, when the combined CSM and commercial product are poured onto a contained fire, they effectively extinguish the flame and form a stable mixture with the cooled combustion byproducts that can be easily swept up and disposed of.

### VIII. Additional Refractory Material Applications

Refractory materials 100 can be provided in a variety of sizes and forms, making them highly adaptable for a diverse range of applications. CSM in particular can be resistant to being displaced or blown away by air pressure. Combining it with other substances confers these benefits to them as well, sees an approximate 500% increase in the amount of force needed to displace the blend compared to the components of the blend which can be useful for remaining effective in the event of a battery fire/release, as the resultant jet of flame can otherwise simply push insulation out of the way.

In further embodiments, refractory materials 100 can be used as an alternative for certain elements to increase the resistance to extreme heat and fire. In some embodiments, refractory materials 100 can be used in combination with or replace magnesium oxide. Refractory materials 100 can complement and/or replace magnesium oxide in the linings of furnaces, kilns, etc., electrical insulation for heating elements, and fire-resistant building materials.

In other embodiments, refractory materials 100 can be used in combination with or replace diatomaceous earth. Refractory materials 100 can complement and/or replace diatomaceous earth in absorption material for large spills and a protection product for food. Diatomaceous earth contains ultra-light-weight forms of silica crystal, such as thin, sharp, respirable flakes. When airborne, these crystals can cause silicosis, a lung disease caused by breathing in the silica dust flakes. Combining with or replacing diatomaceous earth with refractory materials 100 can cause the silica dust to turn into clumps rather than flakes, dissipating the amount of airborne particles. Further, refractory materials 100 can be available in forms and sizes that contain little to no respirable silica fractions, making them a safe replacement in certain applications.

In further embodiments, refractory materials 100 can be used in combination with or replace alumina. Refractory materials 100 can complement and/or replace alumina in lining materials for furnaces, kilns, etc. and electrical insulation for heating elements. Alumina in solid chunks is exceptionally hard to break up and expensive to machine or process into other forms. Further, alumina is amphoteric, which, when in powdered form, makes it vulnerable to attack by acids or bases, therefore it is required to stay as large solid chunks. Refractory materials 100 can allow for various forms to be stored and easily available for varying types of uses.

In additional embodiments, refractory materials 100 can be used in combination with or replace carbon. Refractory materials 100 can complement and/or replace carbon in heat shields and fire protective clothing. Carbon can be chemically incompatible with most acids and bases, whereas refractory materials 100 can be compatible with a wide range of substances and materials.

Refractory materials 100 further can be shaped into, coated onto, or placed within panels and/or containers for military applications. In one embodiment, refractory materials 100 can be put within or used to line fire-resistant panels/boxes as a low cost, high portability passive protective measure. Refractory materials 100 can provide partial or complete protection from the thermal effects of incendiary munitions and nearby fires while also helping to reduce toxic vapors.

Refractory materials 100 can also be placed within custom refractory components to help insulate and protect against corrosive materials or thermal effects. In one embodiment, refractory materials 100 can be used as an alternative to plastic or fiberglass as a means to insulate components of electronic devices. In another embodiment, refractory materials 100 can be placed within custom refractory containers that are used to transport hot molten metal, glass, and/or chemicals. In a different embodiment, refractory materials 100 can be placed within custom refractory panels which can be shaped into complex geometries to protect against spillage, thermal effects, or fire.

Refractory materials 100 can function as inert reaction moderators for industrial and scientific applications. Refractory materials 100 can help to effectively and safely perform reactions that would otherwise be difficult, ineffective, or unsafe due to excessively energetic interactions. The refractory materials 100 can be used to absorb heat and/or slow the rate at which the substances interact with each other. Additionally, refractory materials 100 can be used in inert reaction enhancers or reagent delivery media. These can be used to store, transport, dispense, and introduce chemical or biological reagents into analytical, diagnostic or experimental workflows.

Further, refractory materials 100 can be placed in a variety of products and/or materials to help clean up spillage and/or protect from extreme heat. For example, refractory materials 100 can be placed within fire-resistant articles such as fire blankets and fire-resistant protective gear. In another example, refractory materials 100 can be used as an additive for polymers, plastics, paints, glues, varnishes, waxes, etc. In a further example, refractory materials 100 can be placed within construction materials such as roofing underlayment, natural gas piping sheaths, electrical wiring sheaths, and sheetrock. Additionally, refractory materials 100 can be used as insulation material in a broad range applications, such as gas tank insulation material.

In summary, refractory materials 100 can be available in a variety of sizes and forms, making them highly adaptable for a diverse range of applications. The versatility of refractory materials 100 can allow for integration in a variety of fire-resistant articles and spill control. The flexibility in size and form can allow for the refractory materials 100 to be customizable to meet specific performance and handling requirements for a variety of users.

### IX. Method of Manufacture

In some embodiments, CSM is formed by reclaimed shell molds used in investment casting. Investment casting shell molds are disposed of at the completion of the investment casting process, resulting in millions of tons of ceramic shell waste per year. Instead, the CSM can be manufactured using 100% of the investment casting shell mold material waste and utilized for various containment compound applications.

Investment casting begins by surrounding a disposable pattern of a specific shape with layers of ceramic material. The disposable material used for creating the desired shape is then melted or burned out such that the only remaining material is the ceramic shell. The ceramic shell is then heated to ensure the disposable pattern is completely removed and to strengthen the ceramic material to be able to withstand the stresses of the remaining investment casting processes.

After the initial heating, the ceramic shell receives a molten substance and is heated to temperatures upwards of 1470 degrees Celsius. Upon reaching temperatures between 1470 degrees Celsius and 1710 degrees Celsius, the crystalline structure of silica transforms to β-cristobalite. Once the heating process is complete and the shell cools below 300 degrees Celsius, the bulk of the material undergoes another change to α-cristobalite, decreases in volume, cracks, and releases from the casting. The remaining regions of the shell, however, remain as metastable β-cristobalite. At the completion of the investment casting process, the previously amorphous silica ceramic material has a different particle size and crystalline structure and therefore, has new properties no longer suitable for use in new investment casting shells. Once the shell molds have cracked off the casting, the waste is gathered and crushed down to form the CSM.

CSM formation is not limited to the above-described method of manufacture. For example, CSM and refractory materials 100 of the like may be manufactured by binding CSM particles together via sintering, polymer adhesion, cementation, or other means to produce solid or semisolid shapes out of pure CSM or CSM in combination with a binding agent. CSM may also be manufactured by producing investment casting shells in shapes that can be suitable for subsequent use in their desired application. For example, CSM may be manufactured by producing casting shells with sections that can be readily broken off to forms sheets, boxes, tubes, or other desirable shapes.

### EXAMPLES

### I. Example 1

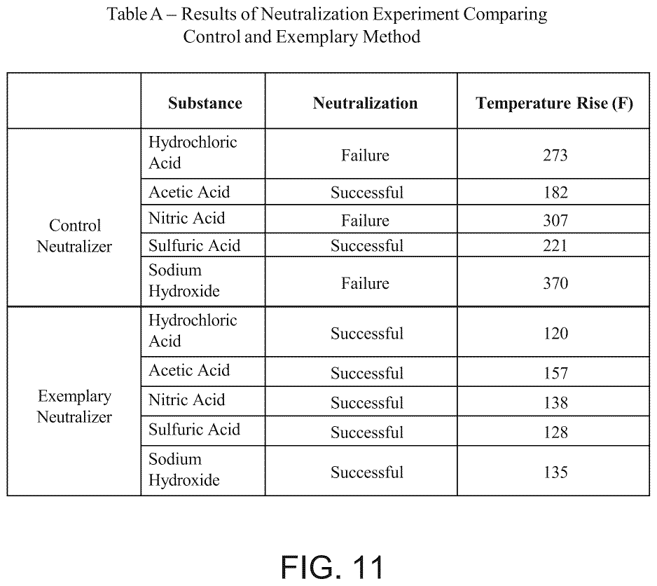

As described above, CSM and other refractory materials may be combined with acid, base, and universal neutralizers to moderate neutralization reactions during spill sorption. A control neutralizer (made from magnesium oxide and an absorbent) and an exemplary neutralizer (the control neutralizer combined with CSM) were subjected to simulated spills of varying acid-base ratios. The substances used for the simulated spills included hydrochloric acid, acetic acid, nitric acid, sulfuric acid, and sodium hydroxide. Two test containers were provided for each substance so that a reaction was observed between each substance and the control and exemplary neutralizers. To measure neutralization reaction efficacy, each container and substance were analyzed to determine whether neutralization occurred. Additionally, the temperature of each container was measured throughout the reaction to determine the total excess heat produced by each reaction over time. Table A, as shown in FIG. 11, displays the results of the simulated neutralization reactions.

As shown by the results, for every substance tested, the exemplary neutralizer facilitated successful neutralization. Meanwhile, the control neutralizer failed to neutralize hydrochloric acid, nitric acid, and sodium hydroxide. Furthermore, the control neutralizer produced excessively hazardous and energetic effects when combined with these substances, resulting in said failures to neutralize effectively. The use of the control neutralizer led to highly exothermic reactions, with temperature rises of 273 degrees for hydrochloric acid, 182 degrees for acetic acid, 307 degrees for nitric acid, 221 degrees for sulfuric acid, and 370 degrees for sodium hydroxide. For every substance tested, the exemplary neutralizer prevented excess temperature rise when compared to the control method. As such, the neutralization reactions were effectively moderated by the exemplary neutralizer. The CSM prevented 153 degrees of temperature rise in the neutralization reaction with hydrochloric acid, as exemplified by the temperature rise of 273 degrees for the control neutralizer and only 120 degrees for the exemplary neutralizer. The CSM prevented 25 degrees of temperature rise in the neutralization reaction with acetic acid, as exemplified by the temperature rise of 182 degrees for the control neutralizer and only 157 degrees for the exemplary neutralizer. The CSM prevented 169 degrees of temperature rise in the neutralization reaction with nitric acid, as exemplified by the temperature rise of 307 degrees for the control neutralizer and only 138 degrees for the exemplary neutralizer. The CSM prevented 93 degrees of temperature rise in the neutralization reaction with sulfuric acid, as exemplified by the temperature rise of 221 degrees for the control neutralizer and only 128 degrees for the exemplary neutralizer. Finally, the CSM prevented 235 degrees of temperature rise in the neutralization reaction with sodium hydroxide, as exemplified by the temperature rise of 370 degrees for the control neutralizer and only 135 degrees for the exemplary neutralizer. These results indicate that CSM moderates and hinders dangerous exothermic effects of the reactions between universal neutralizers and substances of varying acid-base ratio without impacting neutralization effectiveness, rendering these neutralizers safer and more effective. Because CSM comprises similar chemical properties compared to other refractory materials, several other refractory materials would also provide advantages in reaction moderation when combined with universal neutralizers.

### II. Example 2

As described above, CSM and other refractory materials may be disposed within packaging to facilitate the safe transport of corrosive, flammable, or reactive materials, such as lithium-ion batteries. When the batteries experience thermal events, extreme heat conditions may result. To compare the thermal resistance of refractory materials like CSM to other materials traditionally used for flame resistance (perlite and vermiculite), sample containers were either filled with CSM, perlite, vermiculite, or a mixture of CSM and perlite. All the materials were then subjected to two simulated heat emergencies. The sample containers included a cardboard base, ceramic walls, and an open top. Three containers were provided for each of the filler materials so that the heat resistance of the filler materials could be observed when filling containers to variable depths of 5 mm, 10 mm, and 15 mm.

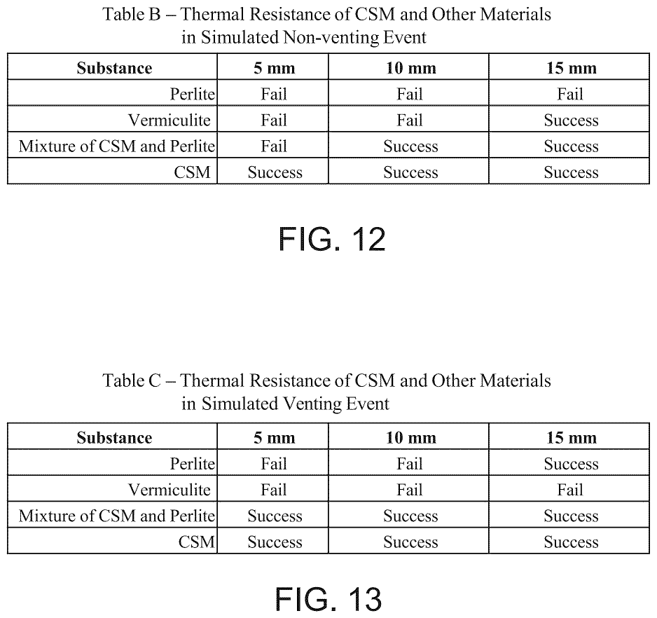

For the first heat emergency, 200 mg of 99.99% pure magnesium was heated to its ignition point and applied to the top surface of the filler material in each sample container. The magnesium was then allowed to burn to completion. This simulated heat emergency imitated a non-venting event of thermal runaway in a lithium-ion battery. Although such an event is not necessarily explosive, this phenomenon can cause a rapid increase in temperature and challenging fires to extinguish. In the simulated heat emergency, a result was designated “success” if the material prevented the cardboard from igniting and a “fail” if the cardboard ignited at any point during the burning of the magnesium. Table B, as shown in FIG. 12, summarizes the results of the simulated non-venting battery event.

The results illustrate that the materials containing CSM withstood the simulated non-venting heat emergency at the lowest depth (5 mm). By itself, CSM was shown to protect the cardboard from ignition even at a depth of only 5 mm, and the perlite containing CSM protected the cardboard at a depth of 10 mm. Meanwhile, vermiculite only succeeded at a depth of 15 mm, and the perlite failed at every depth. This simulated emergency revealed that the CSM was the most efficient material at resisting heat, only needing a layer of 5 mm to protect the cardboard. Moreover, mixing CSM with a less heat-resistant material, such as perlite, will create a material with increased heat resistance.

Identical sample containers were also subjected to a second simulated heat emergency. This heat emergency imitated a venting event of thermal runaway. These events can cause intense fires fueled by flammable gases vented by lithium-ion batteries. To recreate the phenomenon of a venting battery fire, the filler materials within the sample containers were exposed to the flame of a propane torch. The propane torch was moved close to and then away from each material at a steady rate over the course of two seconds, which simulated venting flames from a battery. Like the test above, a result was designated a “success” if the material prevented the cardboard from igniting and a “fail” if the cardboard ignited at any point during the two second flame exposure. Table C, as shown in FIG. 13, summarizes the results of the simulated venting battery event.

Similar to the first heat emergency, the materials containing CSM completely insulated the cardboard from ignition at the lowest depth (5 mm) in the second simulated heat emergency. The CSM and mixture of CSM and perlite both withstood the heat from the butane torch at 5 mm and 10 mm. Meanwhile, all other materials failed this test at these low depths. The perlite also succeeded when the depth was increased to 15 mm. The vermiculite, however, failed to protect the cardboard from the torch at every depth.

Both the heat resistance and displacement resistance of each material was relevant for the second simulated heat emergency. The venting flames had the capability to displace the filler material, sometimes even exposing the area such material was meant to protect. Vermiculite was easily displaced by the force of the butane torch and thus failed to protect that cardboard even after increasing the depth of vermiculite. Alternatively, the CSM and mixture of CSM and perlite were not easily displaced from their containers, and these materials were adequately heat resistant to insulate the cardboard from ignition. The results of this simulated heat emergency illustrate that CSM by itself or mixed with another material can protect packaging material from aggressive, venting flames at low depths.

The simulations described herein demonstrate the efficacy and efficiency of CSM as a thermally resistant material when used in packaging applications. In both simulated heat emergencies, a 5 mm layer of CSM was sufficient to protect cardboard from ignition. Perlite and vermiculite, commonly used for their heat resistance, necessitated a larger layer depth to exhibit the same level of heat resistance as CSM. This efficient heat resistance, coupled with the ability of CSM to comprise substantially the same volume even after absorbing heat, render CSM a preferred material for packaging applications. Because other refractory materials comprise similar thermal resistance as CSM, refractory materials generally offer advantages in packaging of flammable materials.

### III. Example 3

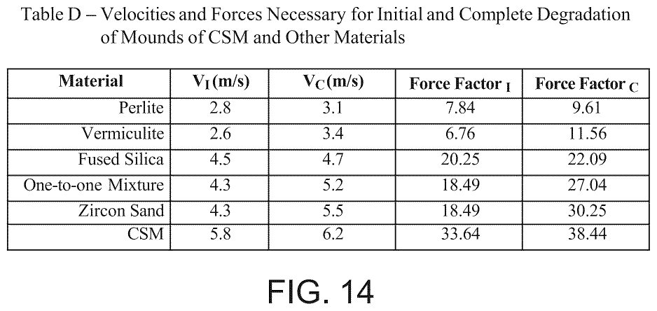

As described in Example 2, to resist an aggressive venting fire, a material must resist both heat and displacement. Alternatively, resistance to displacement is also essential for controlling spills in windy or non-zero ambient airflow conditions. The displacement resistance of refractory materials such as CSM, fused silica, and zircon sand was tested and compared with commercially available materials perlite and vermiculite. CSM and perlite was also tested in a one to one volume mixture. CSM, zircon sand, and fused silica are all refractory materials but differ in chemical composition. CSM is a refractory material with silica content between 70.000 wt. % and 97.000 wt. %, wherein 97.000 wt. % or more of the silica content is in the cristobalite phase. Zircon sand is a refractory material comprising a relatively high zirconia content of around 60.0 wt. % to 70.0 wt. %. Fused silica, meanwhile, is compound with a silica content of 100 wt. %, all of which in the fused silica phase, as described above. To simulate venting forces, 50 cubic centimeters of each material was placed within a trough and arranged into mounds of a similar shape. Then, a variable speed fan was placed approximately 1 meter away at the end of the trough. The output velocity of the fan was increased steadily. An initial velocity measurement VI was taken when the force of the fan began to degrade the mound of each material, and then a second measurement VC was taken when the mound completely degraded. Corresponding force factors Force Factor I (initial force factor) and Force Factor C (complete force factor) were calculated by squaring the two velocity measurements. The force factors are directly proportional to the force required to initially and completely degrade the material mounds. Table D, as shown in FIG. 14, displays the velocity measurements and force factor calculations for each material in response to the variable speed fan.

Of every material tested, the mound of CSM withstood the greatest velocity and force output from the variable speed fan before exhibiting initial and complete degradation. The mound of CSM did not degrade until it was subjected to a velocity of 5.8 m/s and an initial force factor of 33.64. Meanwhile, this velocity and force were sufficient for the complete degradation of all the other mounds of material tested. These results confirm that CSM is more resistant to displacement and venting forces than other materials, and therefore CSM is preferred for use in packaging of items susceptible to accidental venting fires. The high displacement resistance of CSM is also favorable for spill control in windy or non-zero ambient airflow conditions. As indicated above, CSM has a dense physical structure, further characterized by a high cristobalite content, which is why it can resist displacement as seen in this test. Furthermore, a mixture of CSM and perlite also resisted degradation more successfully than perlite alone. The mixture only began to degrade when exposed to a fan velocity of 4.3 m/s, while the perlite was completely degraded by a velocity of 3.1 m/s. CSM can therefore augment the displacement resistance of other materials, rendering such mixed materials more effective for use in packaging applications of materials susceptible to venting fires. Other refractory materials, such as zircon sand and fused silica also offered a higher displacement resistance than perlite and vermiculite. As a result, refractory materials other than CSM also offer advantages over commercially available materials for resistance to venting fires and other displacement-inducing forces.

### IV. Example 4

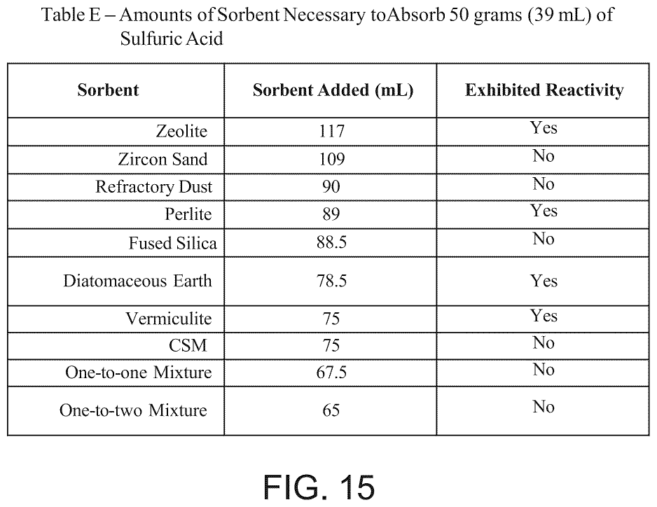

The acid sorption capacity of refractory materials such as CSM, zircon sand, refractory dust, and fused silica were tested and compared against commercially available materials typically used for spill sorption. The CSM, zircon sand, and fused silica used herein comprised substantially similar compositions as described earlier in Example 3. The refractory dust used herein had a relatively high concentration of zirconia and silica oxides. Commercially available sorbents such as zeolite, perlite, diatomaceous earth, and vermiculite were tested for their acid sorption capabilities for comparison. Additionally, one-to-one and one-to-two volume mixtures of CSM and perlite were tested. To simulate acid spill response, ten test containers were each filled with 50 grams, or 39 mL, of sulfuric acid (H₂SO₄), and a different sorbent material was added to each test container until the sorption of the sulfuric acid. The volume of added sorbent material was then isolated and measured in each test container. The reactivity during acid sorption was also analyzed for each material. If sorbents change structure or undergo reactions during sorption, they can render a spill more dangerous and difficult to clean. For example, some reactions between sorbents and acids or bases are intensely exothermic, which makes a spill harder to clean up, more dangerous to its surroundings, and can cause fire hazards. In other instances, the reaction between sorbents and acids or bases produces byproducts with sludgy consistencies, which can be difficult to clean effectively. Table E, as shown in FIG. 15, displays the results of the simulated acid spill.

The results of the simulated acid spill indicate that mixtures of CSM and perlite sorbed 39 mL of sulfuric acid more efficiently than any other singular material. This suggests that CSM can augment the acid sorption capacity of other common sorbents, such as perlite. Furthermore, when used in isolation, CSM and other refractory materials were similarly efficient compared to traditional spill sorbents such as vermiculite and diatomaceous earth. CSM was even more efficient that these materials, due to its porous chemical structure and high cristobalite content. Furthermore, CSM and other refractory materials did not exhibit reactivity in response to the acid like these traditional sorbent materials. Perlite, zeolite, and DE underwent partial to complete liquification in response to the sulfuric acid, leading to sludgy, broken-down consistencies. As described above, such consistencies can make spills more difficult and inconvenient to clean up. Vermiculite also experienced reactivity during sorption. Specifically, vermiculite changed color and expanded in volume. Meanwhile, the refractory materials did not expand in volume and were not broken down by the acid into sludgy consistencies. Consequently, CSM and the other refractory materials offer improvements in acid spill sorption, whether used alone or in combination with other sorbents.

### V. Example 5

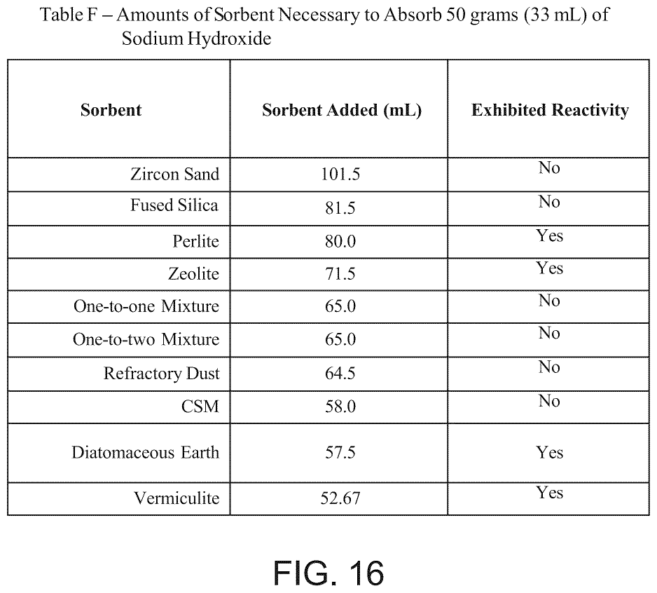

The base sorption capacity of refractory materials such as CSM, zircon sand, refractory dust, and fused silica were tested and compared against other commercially available materials typically used for spill sorption. The CSM, zircon sand, refractory dust, and fused silica used herein comprised substantially similar compositions as described earlier in the Examples. Commercially available sorbents such as zeolite, perlite, diatomaceous earth, and vermiculite were tested for base spill control. Additionally, one-to-one and one-to-two mixtures of CSM and perlite were tested for the same. To simulate base spill response, ten test containers were each filled with 50 grams, or 33 mL, of sodium hydroxide (NaOH), and a different sorbent material was added to each test container until the sodium hydroxide was sorbed. The volume of added sorbent material was then isolated and measured in each test container. The reactivity during base sorption was also analyzed for each material. If sorbents change structure or undergo reactions during sorption, they can render a spill more dangerous and difficult to clean. For example, some reactions between sorbents and acids or bases are intensely exothermic, which makes a spill harder to clean up, more dangerous to its surroundings, and can cause fire hazards. In other instances, as described in Example 4, the reaction between sorbents and acids or bases produces byproducts with sludgy consistencies. Table F, as shown in FIG. 16, displays the results of the simulated base spill.

The results of the base spill indicate that refractory materials such as CSM and refractory dust sorbed 33 mL of sodium hydroxide more efficiently and safely than commercially available sorbents. Also, none of the refractory materials expanded in volume or were broken down or liquified by sodium hydroxide. The stability of refractory materials in response to the sodium hydroxide was attributed to their porous structures and chemical inertness. Conversely, perlite, zeolite, and DE underwent partial to complete liquification in response to the sodium hydroxide, leading to sludgy, broken-down consistencies. Vermiculite also structurally degraded and expanded in volume in response to the sodium hydroxide. The application of DE and zeolite further reacted with the sodium hydroxide and led to exothermic effects. The refractory materials did not exhibit dangerous exothermic reactions, liquification, or expansion in volume during the test. Hence, these materials can be considered safer and more effective for base spill control applications than commercially available sorbents. Even though vermiculite and diatomaceous earth were the most efficient sorbents, only necessitating 52.67 mL and 57.5 mL, respectively, to sorb the sodium hydroxide, these materials also reacted with the base, rendering them less effective overall than CSM and refractory dust. Mixtures of CSM and perlite were also unreactive and efficient sorbents. Moreover, the one-to-one and one-to-two volume mixtures each sorbed the sodium hydroxide with 65 mL of sorbent, while perlite alone needed 80 mL to sorb the sodium hydroxide. Because these mixtures were more effective than and less reactive than perlite alone, the results suggest that CSM can also enhance the base sorption capacity and safety of other materials.

### VI. Example 6

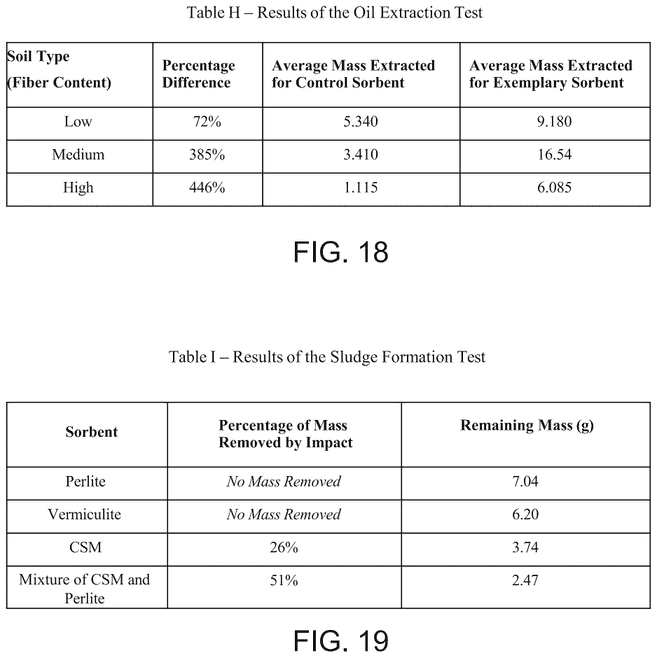

The oil extraction capacity of a control sorbent (perlite) was tested against an exemplary sorbent (mixture of CSM and perlite). Specifically, the control sorbent and exemplary sorbent were compared for their extraction of oil from soils with low, medium, and high plant fiber content. Sample pots were fully filled with one of the types of soil, leveled off to create a flat, even soil surface, and weighed. Thereafter, excess control sorbent or exemplary sorbent was poured onto each soil surface. After an hour, the sorbent was carefully leveled off each soil surface without removing any soil underneath the sorbent. Finally, each sample pot was reweighed to determine the mass of oil extracted from the soil by the sorbent. The average mass in grams of extracted oil from the sample pots was determined for the control and exemplary sorbents across each soil type. Furthermore, a percentage difference was calculated between the average mass extracted by exemplary sorbent and the control absorbent. Results and calculations from the oil extraction test are summarized in Table H, shown in FIG. 18. The exemplary sorbent extracted more oil than the control sorbent for each soil type. The exemplary sorbent extracted 9.180 grams of oil while the control sorbent only extracted 5.340 grams of oil for the low plant fiber soil, representing a 72% improvement. The exemplary sorbent extracted 16.540 grams of oil while the control sorbent only extracted 3.410 grams of oil for the medium plant fiber soil, representing a 385% improvement. The exemplary sorbent extracted 6.09 grams of oil while the control sorbent only extracted 1.12 grams of oil for the high plant fiber soil, representing a 446% improvement. The extraction efficiency of perlite decreased as plant fiber content was increased, suggesting that increased cellulose content hinders the extraction capabilities of perlite. The consistent and considerable improvements of the exemplary sorbent over the control sorbent strongly indicates that CSM can enhance the oil extraction efficiency of perlite, regardless of plant fiber content in soil. The results of this test also indicate that CSM as an additive to other spill control agents can offer advantages in cleaning up hydrophobic substances that are already absorbed by within another material, such as soil.

### VII. Example 7

As mentioned above, CSM and other refractory materials can prevent unwanted sludge-like consistencies that can result when using conventional spill control agents on various spills. Such sludge-like consistencies can cause a spill to stick to its surroundings, which can leave residue that is difficult to remove from said surroundings. CSM was tested against commercially available spill sorbents (perlite and vermiculite) to analyze the ease of residue removal after being applied to a spill of oil. A mixture of CSM and perlite was also tested to observe the effect on spill residue CSM has an additive to conventional spill sorbents. Sample dishes were provided with 5 grams of oil and excess sorbent was added on top of the oil. Once the oil was sorbed, the dishes were inverted, and a weight of 25 grams was dropped on the bases of the dishes from heights of 12 inches. Each dish was then weighed to determine if the sorbent-treated oil left undesirable residue after the impact. The percentages of mass removed by the impacts are indicated in Table I, as seen in FIG. 19.

For the perlite and vermiculite, no mass was removed after the impacts, because the remaining mass within the dish increased beyond the original 5 grams of oil, at 7.04 grams and 6.20 grams respectively, due to the addition of perlite and vermiculite. The perlite and vermiculite created sludgy and sticky consistencies, which could not be sufficiently removed by the force of the impact. Such sludgy consistencies also suggested that sorption was not successful, because the material structures of perlite and vermiculite transformed substantially enough to form a completely different consistency with the oil. Meanwhile, the dishes with CSM and the mixture of CSM and perlite only left 3.74 grams and 2.47 grams of residue after the impacts, equating to 26% and 51% of oil mass removed, respectively. These results indicate that CSM can outperform commercially available materials by reducing the amount of residue after oil spill sorption. The material structure of CSM was stable enough to not break down and form a sticky sludge when combined with oil. Moreover, a mixture of CSM and perlite prevented the tendency of perlite to stick to its surroundings when combined with oil, suggesting that the CSM instead helped perlite stick to the oil and perform proper sorption. Overall, the results of this test indicate that CSM can mitigate sludge-like or otherwise difficult to clean consistencies in hydrophobic spills

### VIII. Example 8

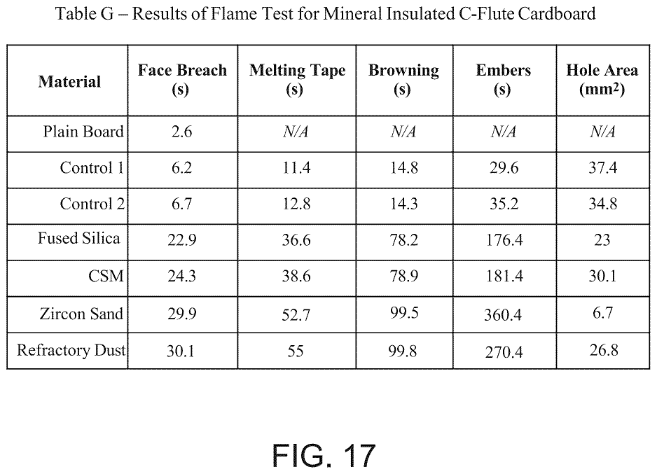

As detailed above, refractory materials can induce increased flame resistance when embedded in cardboard corrugation. To compare this capability of refractory materials to that of commercially available flame-resistant materials, sample c-flute cardboard corrugation was provided and filled with one of two commercially available control materials (control material 1 and control material 2) or a refractory material such as CSM, zircon sand, fused silica, and refractory dust. The CSM, zircon sand, refractory dust, and fused silica used herein comprised substantially similar compositions as described earlier in the Examples. Control material 1 and control material 2 were both traditional water-based flame retardants. Samples of plain, non-insulated piece of cardboard (hereafter “plain board”) were also provided as a control. Thereafter, the front surface of each c-flute cardboard sample was continuously subjected to a 12 mm flame and closely observed. Time was tracked for each cardboard sample until the flame breached the front surface (face breach), melted tape on the rear surface, browned the rear surface, and formed embers on the rear surface. The flame was unlit after ember formation. Additionally, the damage hole area formed on the rear surface after ember formation was also measured, in millimeters squared. The entire process was iterated thrice so that times for three different flute orientations (0, 45, and 90 degrees) could be tested and averaged to model how the cardboard samples would behave in real world fire emergencies. The results of the insulated cardboard flame resistance test, including the hole areas and average times for face breach, melting tape, browning, and ember formation, are displayed in Table G, as shown in FIG. 17.

Cardboard samples insulated with refractory materials, specifically zircon sand and refractory dust, withstood the flame for the longest amounts of time before showing signs of face breach. The zircon sand insulated c-flute experienced face breach at 29.9 seconds, and the refractory dust only experienced face breach at 30.1 seconds. The zircon sand insulated c-flute cardboard also withstood the flame for the longest time before ember formation, at 360.4 seconds, and additionally saw the least amount of flame damage in terms of hole area, at 6.7mm².

In addition, all refractory materials significantly outperformed the two control materials. Cardboard samples containing control material 1 and control material 2 withstood face breach for 6.2 and 6.7 seconds, respectively, while all samples containing refractory materials did not see face breach until at least 22.9 seconds. Similarly, all samples with refractory materials outperformed these two control materials in terms of withstanding tape melting, browning, and ember formation. Samples with control materials 1 and 2 also saw great amounts of damage on the rear surface, at 37.4 mm² and 34.8 mm² respectively, which were larger than the damage observed on samples containing refractory materials. While control materials 1 and 2 do improve cardboard's natural flame resistance, as evidenced by their longer times for face breach than the plain board, all refractory materials included far more significant improvements over the plain board than these control materials. Overall, these results indicate that refractory materials (especially fused silica, CSM, refractory dust, and zircon sand) can enhance the flame resistance of cardboard more than commercially available flame-resistant materials. Zircon sand may protect cardboard corrugation most effectively, as evidenced by the sample with zircon sand experiencing the least amount of damage. This suggests that refractory materials with high relative zirconia content (60 wt. %-70 wt. % in the case of zircon sand) can be preferred for packaging applications requiring flame resistance. Alternatively, refractory materials comprising high cristobalite and fused silica contents can also increase flame resistance.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CLAUSES

Clause 1: A refractory material, comprising: a crystalline lattice structure; a dry weight; and a refractory material composition comprising, based on the dry weight of the refractory material: a silica content of about 70.00% to about 97.00% by weight; the silica content comprising a silica weight and a silica phase composition comprising, based on the silica weight of the silica content about 97.000% to 99.900% by weight of cristobalite and trace amounts of quartz; a zirconia content of about 1.00% to about 7.00% by weight; and an alumina content of about 1.00% to about 5.00% by weight.
Clause 2: The refractory material of clause 1, wherein the crystalline lattice structure comprises a repeating SiO₄ bonds.
Clause 3: The refractory material of clause 1, wherein the crystalline lattice structure comprises a tetragonal framework.
Clause 4: The refractory material of clause 1, wherein the crystalline lattice structure comprises a cubic framework.
Clause 5: The refractory material of clause 1, wherein the silica phase composition comprises fused silica.
Clause 6: The refractory material of clause 1, wherein the refractory material composition comprises, based on the dry weight of the refractory material composition: a magnesium oxide content of about 0.100% to about 0.500% by weight; a sodium oxide content of about 0.100% to about 0.700% by weight; a calcium oxide content of about 0.010% to about 0.100% by weight; and a hafnia content of about 0.010% to about 0.100% by weight.
Clause 7: The refractory material of clause 1, wherein the cristobalite comprises α-cristobalite and metastable β-cristobalite phases.
Clause 8: The refractory material of clause 1, wherein the refractory material composition comprises a zircon phase content of about 1.00% to about 30.00% by weight.
Clause 9: The refractory material of clause 1, wherein the refractory material composition comprises a mullite phase content of about 10.00% to about 40.00% by weight.
Clause 10: A packaging container, comprising a plurality of panels, wherein each panel of the plurality of panels comprises an outer wall; an inner wall spaced from the outer wall to define an interior chamber therebetween; and a corrugation disposed in the interior chamber and coupled to the outer and inner walls to separate the interior chamber into a plurality of flutes; and a first refractory material comprising a first particle size disposed within the plurality of flutes.
Clause 11: The packaging container of clause 10, wherein the panel material can be selected from the group consisting of cardboard, plastics, bio-plastics, metals, fiberglass, wood, fabrics, and paper.
Clause 12: The packaging container of clause 10, wherein the first particle size is between 0.001 mm to 0.01 mm.
Clause 13: The packaging container of clause 10, wherein the plurality of panels comprises a base panel and a side panel extending upward from the base panel, wherein the base panel and the side panel cooperate to define an enclosed space.
Clause 14: The packaging container of clause 13, further comprising a second refractory material disposed in the enclosed space.
Clause 15: The packaging container of clause 14, wherein the second refractory materials is the same as the first refractory material.
Clause 16: The packaging container of clause 13, further comprising a divider panel disposed within and separating the enclosed space into compartments, the divider panel comprising a divider panel material; a first divider panel wall; a second divider panel wall spaced from the first divider panel wall to define a divider panel interior chamber; a divider panel corrugation disposed in the divider panel interior chamber and coupled to the first and second divider panel walls to separate the divider panel interior chamber into a plurality of divider panel flutes; and a divider refractory material disposed in the plurality of divider panel flutes.
Clause 17: The packaging container of clause 16, wherein the divider refractory material is the same as the first refractory material.
Clause 18: The packaging container of clause 10, wherein at least one secondary material is disposed within the plurality of flutes.
Clause 19: The packaging container of clause 10, wherein the inner and outer walls comprise a coating formed of a coating material comprising the first refractory material and at least one auxiliary material.
Clause 20: The packaging container of clause 19, wherein the at least one auxiliary material is paraffin wax.
Clause 21: A refractory material, comprising: a crystalline lattice structure; a dry weight; and a refractory material composition comprising, based on the dry weight of the refractory material: a silica content of about 70.00% to about 97.00% by weight; the silica content comprising a silica weight and a silica phase composition comprising a mixture of fused silica and cristobalite; wherein the mixtures defines a fused silica to cristobalite ratio between 0.01 and 1.
Clause 22: The refractory material of clause 21, wherein the crystalline lattice structure comprises a repeating SiO₄ bonds.
Clause 23: The refractory material of clause 21, wherein the crystalline lattice structure comprises a tetragonal framework.
Clause 24: The refractory material of clause 21, wherein the crystalline lattice structure comprises a cubic framework.
Clause 25: The refractory material of clause 21, wherein the cristobalite comprises α-cristobalite and metastable β-cristobalite phases.
Clause 26: A method of filling packaging, the method comprising: providing a plurality of panels comprising an inner wall, an outer wall, an interior chamber, and corrugation disposed in the interior chamber separating the interior chamber into a plurality of flutes with a receiving end and a bottom end; providing a first end cap on the bottom end of each flute of the plurality of flutes; positioning a funnel in the receiving end of each flute of the plurality of flutes; pouring a first refractory material comprising a first particle size into the funnel until each flute of the plurality of flutes is filled; and providing the receiving end with a second end cap.
Clause 27: The method of filling packaging of clause 26, wherein each panel of the plurality of panels is formed of a panel material selected from the group consisting of cardboard, plastics, bio-plastics, metals, fiberglass, wood, fabrics, and paper.
Clause 28: The method of filling packaging of clause 26, wherein the first particle size is between 0.001 mm to 0.01 mm.
Clause 29: The method of filling packaging of clause 26, wherein the plurality of panels comprises a base panel and a side panel extending upward from the base panel, wherein the base panel and the side panel cooperate to define an enclosed space.
Clause 30: The method of filling packaging of clause 26, further comprising a second refractory material disposed in the enclosed space.
Clause 31: The method of filling packaging of clause 30, wherein the second refractory materials is the same as the first refractory material.
Clause 32: The method of filling packaging of clause 29, further comprising a divider panel disposed within and separating the enclosed space into compartments, the divider panel comprising a divider panel material; a first divider panel wall; a second divider panel wall spaced from the first divider panel wall to define a divider panel interior chamber; a divider panel corrugation disposed in the divider panel interior chamber and coupled to the first and second divider panel walls to separate the divider panel interior chamber into a plurality of divider panel flutes; and a divider refractory material disposed in the plurality of divider panel flutes.
Clause 33: The method of filling packaging of clause 32, wherein the divider refractory material is the same as the first refractory material.
Clause 34: The method of filling packaging of clause 26, wherein at least one secondary material is disposed within the plurality of flutes.
Clause 35: The method of filling packaging of clause 26, wherein the inner and outer walls comprise a coating formed of a coating material comprising the first refractory material and at least one auxiliary material.
Clause 36: The packaging container of clause 19, wherein the at least one auxiliary material is paraffin wax.

1. A refractory material, comprising:
a crystalline lattice structure;
a dry weight; and
a refractory material composition comprising, based on the dry weight of the refractory material:
a silica content of about 70.00% to about 97.00% by weight;
the silica content comprising a silica weight and a silica phase composition comprising, based on the silica weight of the silica content about 97.000% to 99.900% by weight of cristobalite and trace amounts of quartz;
a zirconia content of about 1.00% to about 7.00% by weight; and
an alumina content of about 1.00% to about 5.00% by weight.

2. The refractory material of claim 1, wherein the crystalline lattice structure comprises a repeating SiO₄ bonds.

3. The refractory material of claim 1, wherein the crystalline lattice structure comprises a tetragonal framework.

4. The refractory material of claim 1, wherein the crystalline lattice structure comprises a cubic framework.

5. The refractory material of claim 1, wherein the silica phase composition comprises fused silica.

6. The refractory material of claim 1, wherein the refractory material composition comprises, based on the dry weight of the refractory material composition:
a magnesium oxide content of about 0.100% to about 0.500% by weight;
a sodium oxide content of about 0.100% to about 0.700% by weight;
a calcium oxide content of about 0.010% to about 0.100% by weight; and
a hafnia content of about 0.010% to about 0.100% by weight.

7. The refractory material of claim 1, wherein the cristobalite comprises α-cristobalite and metastable β-cristobalite phases.

8. The refractory material of claim 1, wherein the refractory material composition comprises a zircon phase content of about 1.00% to about 30.00% by weight.

9. The refractory material of claim 1, wherein the refractory material composition comprises a mullite phase content of about 10.00% to about 40.00% by weight.

10. A packaging container, comprising:
a plurality of panels, wherein each panel of the plurality of panels comprises:
an inner wall;
an outer wall spaced from the inner wall to define an interior chamber therebetween; and
a corrugation disposed in the interior chamber and coupled to the inner wall and outer wall to separate the interior chamber into a plurality of flutes; and
a first refractory material comprising a first particle size disposed within the plurality of flutes.

11. The packaging container of claim 10, wherein a panel material can be selected from the group consisting of cardboard, plastics, bio-plastics, metals, fiberglass, wood, fabrics, and paper.

12. The packaging container of claim 10, wherein the first particle size is between 0.001 mm to 0.01 mm.

13. The packaging container of claim 10, wherein the plurality of panels comprises at least one base panel and at least one side panel extending upward from the at least one base panel, wherein the at least one base panel and the at least one side panel cooperate to define an enclosed space.

14. The packaging container of claim 13, further comprising a second refractory material disposed in the enclosed space.

15. The packaging container of claim 14, wherein the second refractory material is the same as the first refractory material.

16. The packaging container of claim 13, further comprising:
a divider panel disposed within and separating the enclosed space into compartments, the divider panel comprising:
a divider panel material;
a first divider panel wall;
a second divider panel wall spaced from the first divider panel wall to define a divider panel interior chamber;
a divider panel corrugation disposed in the divider panel interior chamber and coupled to the first and second divider panel walls to separate the divider panel interior chamber into a plurality of divider panel flutes; and
a divider panel refractory material disposed in the plurality of divider panel flutes.

17. The packaging container of claim 16, wherein the divider panel refractory material is the same as the first refractory material.

18. The packaging container of claim 10, wherein at least one secondary material is disposed within the plurality of flutes.

19. The packaging container of claim 10, wherein the inner wall and outer wall comprise:
a coating formed of a coating material comprising:
the first refractory material;
and at least one auxiliary material.

20. The packaging container of claim 19, wherein the at least one auxiliary material is paraffin wax.
